(19) United States
(12) Patent Application Publication
(10) Pub. No.: US 2009/0178968 A1
(43) Pub. Date: Jul. 16, 2009

(54) Water treatment apparatus

(76) Inventor: Ian Geoffrey Cummins, Gaven Queensland (AU)

Correspondence Address: Martin P Hoffman;Hoffman Wasson & Gitler, 2461 South Clark Street, Suite 522, Arlington, VA, 22202, US

(21) Appl. No.: 11/991,160

(22) PCT Filed: Sep. 4, 2006
(86) PCT No.: PCT/AU2006/001280

§ 371 Date: Feb. 28, 2008

(30) Foreign Application Priority Data
Sep. 2, 2005 (AU) 2005904812
Oct. 28, 2005 (AU) 200505966
Jan. 17, 2006 (AU) 2006900216
Mar. 24, 2006 (AU) 2006901510

(51) Int. Cl. C02F 1/24; C02F 1/40; C02F 1/78; C02F 1/74; C02F 1/32

(52) U.S. Cl. 210/221.2

(57) ABSTRACT

Water purification or treatment apparatus (410) including a plurality of elongated water treatment chambers (433), each chamber (433) being normally oriented in a substantially vertical attitude, return pipes (434) interconnecting the chambers (433) whereby water to be treated flows in series through the respective chambers (433), gas outlets (443) for supplying gas such as ozone to the respective chambers (433) for bubbling upwardly through water flowing in the chambers (433) and creating a foam at the upper surface of water in the chamber (433) and means (440) for collecting the foam.

### TECHNICAL FIELD

This invention relates to water treatment apparatus which is particularly suited for treating water for the purposes of purifying, cleaning or otherwise removing impurities or contaminants in the water. The apparatus of the present invention is particularly suited to treatment of grey water, drinking water, swimming pool water, water from aquaculture systems, sewerage water, and water from vehicle washing apparatus which contain soap and detergent suds and other contaminants. The present invention may also be applied to the removal of salt from salt water to provided drinking or potable water in a desalination process.

### BACKGROUND ART

The treating of water for the purposes of purifying the water or removing contaminants from water has become an increasing problem to growing communities where increasing volumes of effluent or contaminated water is generated. Contaminated water can be generated in domestic, commercial and agricultural situations. Often such water receives primary treatment and is then simply left in settling ponds where solids settle out. With water shortages it is highly desirable that the contaminated water be treated so as to enable it to be reused or recycled

Automated and non-automated vehicle washing apparatus use considerable quantities of water in washing vehicles. Water which is used in the vehicle washing process can be contaminated with soap and detergent suds used in the washing process as well as grease, oil, brake pad dust, road grime and other contaminants. Furthermore, a considerable volume of water is used in the washing process which is obviously undesirable from the point of view of water conservation. It would be desirable therefore to have an effective means for re-using or re-cycling water used in vehicle washing apparatus for the purposes of conserving water. Difficulties however are encountered in reusing water from vehicle washing apparatus because of the contaminants in the water used in the washing process.

### SUMMARY OF THE INVENTION

The present invention aims to provide improved water purification or treatment apparatus for purifying and/or removing particles, and/or contaminants suspended or dissolved in water. The apparatus of the invention may be used independently or be combined with other water treatment apparatus such as a screen or drum filter and an ultraviolet light treatment unit for water treatment purposes. The apparatus of the present invention may be used for treating water in many different applications as well as for treating salt water for the purposes of removal of salts or other dissolved chemicals in salt water. Other objects and advantages of the invention will become apparent from the following description.

The present invention thus provides in one preferred aspect, water purification or treatment apparatus including a plurality of elongated water treatment chambers, each said chamber being normally oriented in a substantially vertical attitude, means interconnecting said chambers whereby water to be treated flows in series through the respective said chambers, means for supplying a gas to the respective said chambers for bubbling upwardly through water flowing in, said chambers and creating a foam at the upper surface of water in said chambers and means for collecting said foam.

Preferably water is supplied to said chambers to flow downwardly through the respective said chambers.

Preferably an inlet for water to be treated is provided at an upper region of each chamber. Each chamber suitably also includes an outlet for water at a lower region thereof. Preferably the outlet of one chamber is connected to the inlet of an adjacent chamber such that water flows sequentially from one chamber to the adjacent chamber. An inlet may be defined in or by an upper end of a chamber. The outlet may also be defined in or by a lower end of the chamber.

The gas most suitably comprises ozone or ozone enriched air but may comprise another gas or combination of gases. Ozone may be generated by ultraviolet lamps located in housings through which an oxygen containing gas is pumped

The term “water” as used throughout the specification includes contaminated water or any other water or liquid carrying impurities or solids including salt water.

In one form the foam collecting means comprise foam passages extending upwardly from the upper ends of the respective chambers. As the foam collecting passage extends upwardly from the water flow passage, water condensing from the foam in the foam collecting passage will fall under the influence of gravity back towards the water flow passage for further treatment by exposure to bubbles of gas. Alternatively the foam passages may include a trap or traps to prevent foam passing back into the chambers. The trap or traps may be in the form of an inverted U-shaped member or members or other means to direct the foam at the upper ends of the chambers downwardly away from the chambers.

The foam passages may be connected to a common foam waste passage or passages for receiving foam from the foam passages and for directing the foam to waste or for further processing and treatment. The common foam waste passage suitably extends transversely of the water treatment chambers. The foam waste passage in one form is substantially horizontal. In another form, the foam waste passage is inclined upwardly from the horizontal from the leading chamber towards the trailing chamber. In a particularly preferred form however, the foam waste collecting passage is inclined downwardly from the horizontal from the leading chamber towards the trailing chamber. This ensures that foam in the successive trailing chambers which usually rises to successively lower levels from the leading chamber can be collected. In an alternative or additional configuration, the foam passages may be of different cross sections. In a particularly preferred form, the successive foam passages are of reducing cross section. The common foam waste passage may be located above the water treatment chambers or disposed below the upper ends of the respective chambers.

The foam from the common foam waste passage may be received in a holding container in which water is condensed and which may be directed back to the water treatment apparatus for further treatment. The holding container may have an outlet at its lower end through which solids may be released. The outlet may be a valve-controlled outlet. The container may also include a foam inlet at its upper end and a water outlet at its lower end for outward flow of condensing water. Means may be provided to direct air or a spray of water or liquid over the foam in the container to break down the foam.

In another form, the holding container may have a rotatable drum which reduces the foam to water liquid. The drum may have a perforated wall through which the water or liquid may pass and an inlet may direct foam to be treated to the interior of the drum. The inlet is preferably arranged along or in alignment with the axis of rotation of the drum. In yet another form the holding container may include means to reduce the volume of the foam in the container. Such means may comprise a heating element or alternatively a microwave emitter or ultrasonic vibrator.

Preferably the means for supplying gas to the chambers comprises one or more gas outlets at the lower end of the chambers. The gas outlet or outlets means may comprise one or more air stones, a gas permeable pipe or pipes, a diffuser or diffusers or other form of outlet. Contaminants or solids in a chamber will be conveyed by bubbles of gas to the upper end of the chamber where the foam is formed and passes up the foam passage for collection and direction to the common foam waste passage. Alternatively, impurities in the water such as heavy metals may be broken down by the gas typically ozone bubbling through the water in the chamber.

Preferable the water treatment apparatus includes return passages connected to the water treatment chambers for conveying water to be treated between the respective chambers. A return passage may be connected to an outlet at a lower end of one chamber and extend upwardly therefrom such that water flows in the return passage in a direction opposite the flow in the chamber. The return passage may have a flow cross-section the same as or less than the flow cross-section of the chambers. The return passages may be substantially parallel to the chambers or angled to the chambers.

A gas outlet or outlets is/are may be provided for supplying gas to the lower end of the return passage for bubbling through water flowing in the return passage. Preferably the bubbles in the return passage move in the same direction as water flowing through the return passage to assist by an air lift or venturi effect in water flow through the return passages. The gas outlet for supplying gas to the return passage may comprise a gas inlet or nozzle.

The chambers and return passages may be defined by first and second pipes. The first and second pipes may be connected by pipe connectors forming a U-connection between the pipes. The U-connectors may comprise two ninety-degree pipe, connectors. Alternatively the first and second passages may be defined by a single pipe bent 180 degrees to form two pipe sections defining the respective passages. Alternatively, the first and second pipes may be connected through a manifold located at the lower end of the first and second pipes.

The term “pipe” as used throughout the specification includes any elongated hollow member defining a flow passage of any cross section.

Where the first and second pipes are connected to a common manifold, the means for supplying gas to the first and second pipes may comprise gas outlets or nozzles provided in the common chamber.

The collecting means for receiving foam may be defined by a further pipe or pipe connectors. Preferably the filter pipe is connected directly or indirectly to the upper end of the first pipe. The further pipe may be connected to the upper end of the first pipe by any suitable pipe connector or connectors. Alternatively a further manifold may be provided at and connected to the upper end of the first pipe and the further pipe for foam may be connected to the further manifold to receive foam collecting in the further manifold.

In a particularly preferred form, the water treatment apparatus includes a plurality of sets of first and second pipes arranged in series. Preferably the upper end of the second pipe of one set of pipes is connected directly or indirectly to the upper end of the first pipe of the next set of pipes. The pipes are suitably arranged substantially parallel to each other.

The manifolds which provide communication between the respective pipes may comprise tubular manifolds divided by barriers into respective chambers which communicate with respective pipes.

The water treatment apparatus may be connected to an ultraviolet treatment unit. The ultraviolet treatment unit may comprise an upright passage in which an ultraviolet lamp or lamps is/are located. The upright passage may also be defined by a pipe which houses the ultraviolet lamp or lamps. A pair of passages may be located adjacent to each other and connected at their lower end so as to be of a U-shaped configuration. Inlets for water to be treated may be provided at the upper ends of the passages. A common outlet from the ultraviolet treatment unit suitably communicates with the lower ends of the passages and suitably to the connection between the lower ends of the passages

The present invention provides in another preferred aspect, water purification or treatment assembly including a de-foaming unit, and an ozone contacting unit, each said unit comprising water treatment apparatus of the above described type, and means for causing water to be treated to pass through said defoaming unit and said ozone contacting unit. Water to be treated may be supplied from a holding tank initially to the defoaming unit for foam removal after which it is returned to the or a further holding tank. Water from the or further holding tank is then supplied to the ozone-contacting unit for subjecting the water to ozone.

Preferably the outlet of the ozone-contacting unit is connected to an ultraviolet treatment unit for exposing the water to ultraviolet light. The outlet of the ultraviolet treatment unit may be connected to a screen filtering unit.

The defoaming unit and ozone treatment unit may be comprised of one or more modules and suitably a pair of modules arranged in parallel. Each module suitably includes one or more water treatment apparatuses of the above described type suitably arranged in series.

Preferably means are provided to add a foaming agent to water being treated such as water supplied to the inlet to assist in removing impurities from the water such as heavy metals. The foaming agent may comprise an environmentally friendly detergent or any frothable agent such as molasses. Adding such a foaming agent to in water to be treated creates a foam which will carry heavy metals upwardly through the pipes for collection in the waste or foam pipes which are directed to waste.

The present invention provides in other preferred aspect, water treatment apparatus including a first water flow passage, said passage being normally oriented in a substantially vertical attitude, means for supplying water to be treated to said passage for flow of water in a first direction along said passage towards one end of said passage, means for supplying a gas to said passage for bubbling through said water flowing in said passage and a waste collector for collecting waste at an upper end of said passage.

Preferably the means for supplying gas to the water flow passage comprises one or more gas outlets at the lower end of the passage. The gas outlet or outlets may comprise one or more air stones, a gas permeable pipe or pipes or other form of outlet. Contaminants or solids in the first passage including heavy metals may be conveyed by bubbles of gas to the upper end of the first passage. Alternatively, impurities in the water such as heavy metals may be broken down by the gas typically ozone bubbling through the water in the first passage. Any waste carried by the bubbles to the upper end of the passage passes into the waste collector.

Preferably, the water flows from the upper end towards a lower end of the first passage and the bubbles flow from the lower end towards the upper end of the first passage.

Preferable the apparatus includes at least one second water passage connected to the first water passage. The at least one second water passage may be connected directly or indirectly to the lower end of the first water passage and extend upwardly therefrom such that water flows in the second passage in a direction opposite the first passage. The at least one second passage may have a flow cross-section less than the flow cross-section of the first passage. Suitably the at least one second passage is substantially parallel to the first passage. More than one second passage may be provided.

A gas outlet or outlets is/are also suitably provided for supplying gas to the lower end of the at least one second passage for bubbling through water flowing in the second passage. Preferably the bubbles in the second passage move in the same direction as water flowing through the second passage to assist by an air lift or air pump principle water flow through the at least one second passage. As an alternative an air or liquid pump may be associated with the at least one second passage for pumping liquid through the at least one second passage.

The waste collector for receiving waste may be defined by a further pipe or pipe connector. Preferably the further pipe or pipe connector is connected directly or indirectly to the upper end of the first pipe, A further chamber may be provided at and connected to the upper end of the first pipe and the further pipe or pipe connector for waste may be connected to the further chamber to receive wastes carried upwardly to the further chamber. An inlet for water to be treated may be connected to the further chamber. The further pipe or pipe connector may comprise a U-shaped pipe or connector.

In a particularly preferred form, the water treatment apparatus may include a plurality of sets of first and at least one second passage arranged in series. Preferably the upper end of the at least one second passage of one set of passages is connected directly or indirectly to the upper end of the first passage of the next set of passage. The passages of the respective sets are suitably arranged substantially parallel to each other. The tipper ends of the respective passages may be connected through a common chamber.

### BRIEF DESCRIPTION OR THE DRAWINGS

In order that the invention may be more readily understood and put into practical effect reference will now be may to the accompanying drawings which illustrate preferred embodiments of the invention and wherein:

FIG. 1 is an isometric view of water treatment apparatus according to a first embodiment of the invention;

FIGS. 2, 3, and 4 are top, side and end views of the apparatus of FIG. 1;

FIG. 5 is a sectional view along line A-A of FIG. 2;

FIGS. 6 (a), (b), (c), and (d) illustrate in perspective, top and different side views an alternative water treatment apparatus according to another embodiment of the invention;

FIGS. 7 (a), (b), (c), and (d) illustrate in perspective, top and side and end views an alternative water treatment apparatus according to another embodiment of the invention;

FIGS. 8 (a), (b), (c), and (d) illustrate in perspective, top, side and end views an alternative water treatment apparatus according to another embodiment of the invention;

FIGS. 9 (a), (b), (c), and (d) illustrate in opposite perspective, top, side and end views an alternative water treatment apparatus according to another embodiment of the invention;

FIGS. 10 (a), (b), (c), and (d) illustrate in perspective, top, side and end views an alternative water treatment apparatus according to another embodiment of the invention;

FIG. 11 is a perspective view of an alternative water treatment apparatus according to the invention;

FIGS. 12, 13, and 14 are top, end and side views of the apparatus of FIG. 11;

FIG. 15 is a sectional view along line B-B of FIG. 12;

FIGS. 16 (a), (b), (c), and (d) illustrate in views corresponding to FIGS. 11 to 14, a further water treatment apparatus according to the invention;

FIGS. 17 (a), (b), (c), and (d) illustrate in views corresponding to FIGS. 11 to 14 yet an alternative apparatus according to the invention;

FIGS. 18 (a), (b), (c), (d) and (e) illustrate in opposite perspective, top, side and end views a water treatment installation including further water treatment apparatus.

FIG. 19 is an isometric view of water treatment apparatus according to another embodiment of the invention;

FIGS. 20 (a), (b) and (c) are top, side and end views of the apparatus of FIG. 19;

FIG. 21 is an isometric view of water treatment apparatus according to a further embodiment of the invention;

FIGS. 22 (a), (b) and (c) are top, side and end views of the apparatus of FIG. 21;

FIG. 23 is an isometric view of water treatment apparatus according to a further embodiment of the invention;

FIGS. 24 (a) and (b) side and end views of the apparatus of FIG. 23;

FIG. 25 is top view of the apparatus of FIG. 23;

FIG. 26 is a sectional view along line A-A of FIG. 25,

FIG. 27 is an isometric view of water treatment apparatus according to a further embodiment of the invention;

FIGS. 28 (a), (b) and (c) are top, side and end views of the apparatus of FIG. 27;

FIG. 29 is an isometric view of water treatment apparatus according to a further embodiment of the invention;

FIGS. 30 (a), (b) and (c) are top, side and end views of the apparatus of FIG. 29;

FIG. 31 is an isometric view of water treatment apparatus according to a further embodiment of the invention;

FIGS. 32 (a), (b) and (c) are top, side and end views of the apparatus of FIG. 31;

FIGS. 33 and 34 are opposite isometric views of apparatus according to a further embodiment of the invention;

FIGS. 35 (a) and (b) are side and end views of the apparatus of FIG. 33;

FIG. 36 is top view of the apparatus of FIG. 33;

FIG. 37 is a sectional view along line B-B of FIG. 36;

FIG. 38 is an isometric view of a water treatment apparatus according to a further embodiment of the invention;

FIG. 39 is side view of the apparatus of FIG. 38;

FIG. 40 is a sectional view, along line C-C of FIG. 39;

FIG. 41 is a top view of the apparatus of FIG. 38;

FIG. 42 is a sectional view along line D-D of FIG. 41;

FIG. 43 is an enlarged view of the region F of FIG. 42;

FIG. 44 is an isometric view of a water treatment installations according to a further embodiment of the invention;

FIGS. 45 (a), (b) and (c) are side end and top views of the installations of FIG. 44;

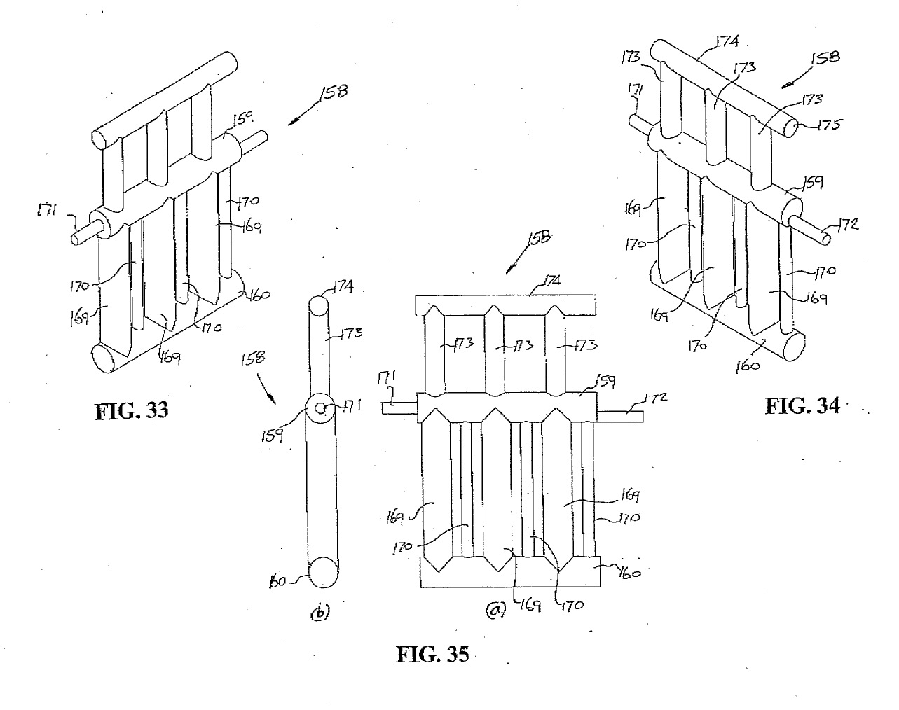

FIG. 40 is an isometric view of the apparatus of FIGS. 33 and 34 associated with a drum filter module;

FIGS. 47 (a) and (b) are side and top view of the assembly of FIG. 46;

FIGS. 48 and 49 are an isometric view and side view respectively of water purifying or treatment apparatus according to an embodiment of the invention associated with a foam reduction/water recovery tank;

FIG. 50 is a plan view of the apparatus of FIGS. 48 and 49;

FIG. 51 is an enlarged sectional view along line A-A of FIG. 50;

FIGS. 52 and 53 are plan and side views of the foam reduction/water recovery tank;

FIG. 54 is an enlarged sectional view of the tank along line B-B of FIG. 52;

FIGS. 55, 56 and 57 illustrate in isometric plan and side views an alternative water purifying apparatus according to another embodiment of the invention;

FIG. 58 is an isometric view of water purifying or treatment apparatus associated with an alternative foam reduction/water recovery apparatus;

FIGS. 59 and 60 illustrate the foam reduction/water recovery apparatus in plan and side views;

FIG. 61 is an isometric view of the foam reduction/water recovery apparatus showing the interior drum;

FIG. 62 is a sectional view along line C-C of FIG. 59.

FIG. 63 is an isometric view of a water treatment installation according to another embodiment of the invention;

FIGS. 64 and 65 illustrate the installation of FIG. 63 in front and plan view;

FIGS. 66 (a), (b) and (c) illustrate the installation of FIG. 63 in isometric, plan and front view respectively;

FIGS. 67 (a), (b) and (c) illustrate the ozone contacting unit of the installation of FIG. 63 in isometric, plan and flint view respectively;

FIGS. 68(a), (b) and (c) are a side view, plan view, and a sectional view along line A-A of FIG. 68(b), of a first water treatment device of the defoaming unit and ozone contacting unit of FIGS. 66 and 67;

FIGS. 69(a), (b) and (c) are a side view, plan view, and a sectional view along line B-B of FIG. 69(b) of a second water treatment device of the defoaming unit and ozone contacting unit of FIGS. 66 and 67;

FIGS. 70(a), (b) and (c) are a side view, plan view, and a sectional view along line C-C of FIG. 70(b), of a third water treatment module of the defoaming unit and ozone contacting unit of FIGS. 66 and 67;

FIGS. 71 (a) (b) (c) and (d) illustrate an isometric view, front view, plan view and side views a water treatment module comprising interconnected treatment devices of FIGS. 68 to 70;

FIGS. 72 (a) (b) (c) and (d) illustrate an isometric view, front view, plan view and sectional view along line D-D of FIG. 72(c), an ozone producer for use in the apparatus of FIG. 63;

FIG. 73 (a) (b) (c) and (d) illustrate in opposite isometric views, front and plan views, an ultraviolet treatment unit for use in the apparatus of FIG. 63;

FIG. 74 is a sectional view along line E-E of FIG. 73 (d);

FIG. 75 is a sectional view along line F-F of FIG. 73 (c).

FIG. 76 is an isometric view of a water treatment apparatus according to another embodiment of the invention;

FIGS. 77, 78 and 79 illustrate the apparatus of FIG. 76 in front and opposite end views;

FIG. 80 is a plan view of the water treatment unit of the apparatus of FIG. 76;

FIGS. 81, 82 and 83 illustrate the water treatment unit of FIG. 76 in font and opposite end views;

FIG. 84 is a sectional view along line A-A of FIG. 80;

FIG. 85 is an enlarged view of the region B of FIG. 84;

FIG. 86 illustrates a drain filter module;

FIGS. 87 and 88 illustrate the water treatment apparatus of FIG. 76 combined with the drum filter module of FIG. 86;

FIGS. 89 and 90 illustrate end and rear views of the combination of FIGS. 87 and 88;

FIGS. 91 and 92 illustrate the water treatment apparatus of FIG. 76 in a different combination with the drum filter module of FIG. 86;

FIGS. 93 and 94 illustrate in end and rear views, the combination of FIGS. 91 and 92

FIGS. 95 and 96 are opposite isometric views of an alternative water treatment apparatus according to another embodiment of the invention;

FIGS. 97 and 98 are opposite side views of the water treatment apparatus of FIGS. 95 and 96;

FIGS. 99, 100 and 101 illustrate in perspective, side and end views, an ozone contact chamber of the apparatus of FIGS. 95 to 98;

FIG. 102 is a sectional view along line A-A of FIG. 102;

FIGS. 103 and 104 illustrate in side and plan view, a foam reduction chamber for use with the apparatus of FIGS. 95 to 98; and

FIG. 105 is a sectional view of the chamber along line B-B of FIG. 104.

### DETAILED DESCRIPTION OF THE PREFERRED EMBODIMENTS

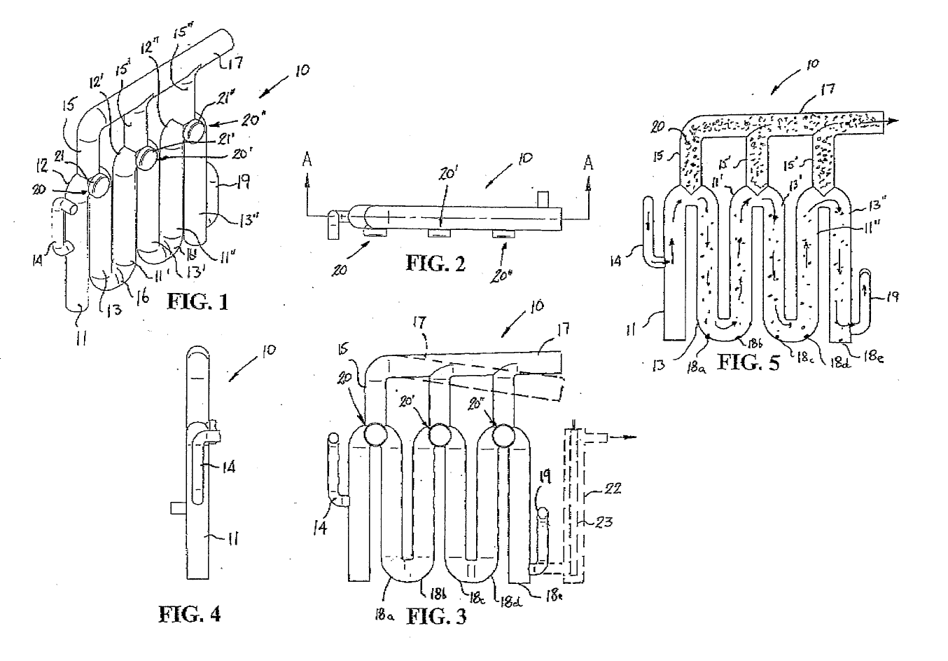

Referring to the drawings and firstly to FIGS. 1 to 5, there is illustrated water treatment apparatus 10 according to an embodiment of the invention typically for treating contaminated water such as grey water, or water from a vehicle washing establishment or for treating any other water. The apparatus 10 includes a series of interconnected pipes comprising a first upright pipe 11 which is connected at its upper end through a U-connector or alternative connector 12 to a second upright pipe 13, the pipes 11 and 13 being substantially parallel to each other. The first pipe 11 has an inlet 14 for untreated water whilst an upright foam-collecting pipe 15 is connected to the upper ends of the first and second pipes 11 and 13 at the connector 12.

The apparatus 10 includes further sets of interconnected pipes 11′ and 13′ and 11″ and 13″ corresponding to the pipes 11 and 13 respectively with the respective pipes 11′ and 11″being connected at their lower ends via connectors 16 and 161 to the pipes 13 and 13′ of the preceding set of pipes with the pipes 11′ and 13′ and 11″ and 13″ being interconnected at their upper ends through connectors 12′ and 12″. Further upright foam collection pipes 15′ and 15″ are connected at the connectors 12′ and 12″ to the upper ends of the joined pipes 11′ and 13′, and 11″ and 13″respectively. The foam collection pipes 15, 15′ and 15″ are connected at their upper ends to a common waste pipe 17 which in the illustrated embodiment extends transversely to the pipes 15, 15′ and 15″ and is inclined upwardly from the first collection pipe 15 towards the pipe 15″. The waste pipe 17 however may be arranged to lie in a substantially horizontal plane or be inclined downwardly from the first collection pipe 15.

Respective gas outlets 18a, 18b, 18c, 18d, and 18e are provided at the lower ends of the respective pipes 13, 11′, 13′, 11″ and 13″. In this embodiment, the outlets 18a, 18c and 18e are connected to a source of ozone whilst the inlets 18b and 18d are connected to a source of air. The gas outlets 18a, 18b, 18c, 18d and 18e may be in the form of nozzles, or venturis which penetrate the pipes or air stones, perforated pipes or other forms of outlets internally of, and at the lower ends of the pipes. A treated water outlet 19 is provided at the lower end of the pipe 13″.

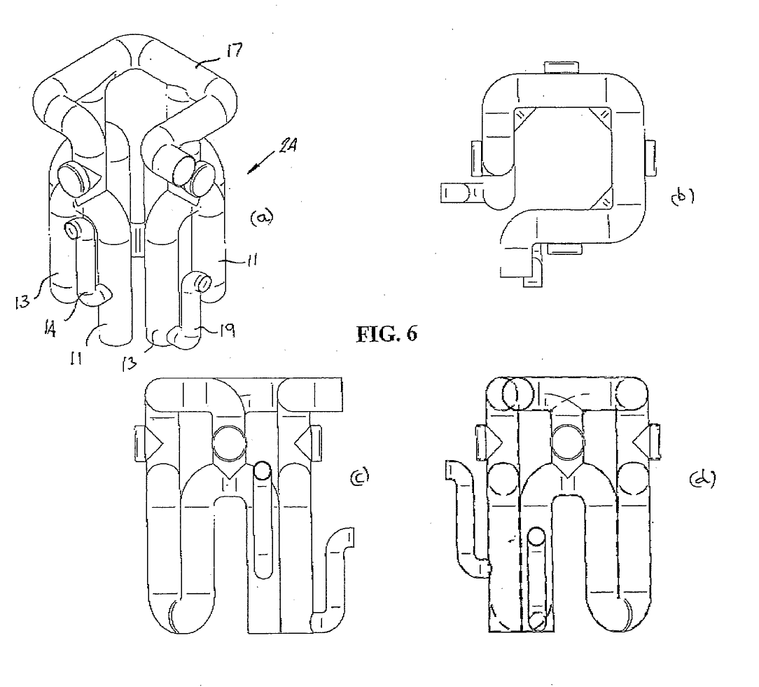

In use water to be treated is supplied to the inlet 14 for flow into the pipe 11. The region of the pipe 11 beneath the inlet 14 acts as a, trap for solids. Water flows upwardly through the pipe 11 and downwardly through the pipe 13 as indicated by the arrows in FIG. 5. Ozone supplied to the gas outlet 18a bubbles upwardly through the water flowing downwardly through the pipe 13 so that water flowing therein is exposed to the sterilizing effect of ozone. Bubbles of gas reaching the upper end of the pipe 13 create foam 20 which carries contaminants in the water. The foam will pass upwardly through the pipe 15 into the waste pipe 17 where it is directed to waste.

Water flow continues from the pipe 13 to the pipe 11′ wherein it flows upwardly. Air supplied to the outlet 18b bubbles through the water flowing in the pipe 11′ in the same direction as the water flow. This assists in the water flow through the pipe 11′ as well as removing contaminants in the water which creates further foam at the upper end of the pipe 11′. Further foam is created by ozone which is supplied to the outlet 18c for bubbling through water in the pipe 13′ in a direction opposite to the water flow through the pipe 13′. This treatment procedure is repeated in the respective pipes 11″ and 13″ with air being supplied to the outlets 18d and ozone to the outlets 18e. Water thus flows in a serpentine manner through the apparatus 10. Foam collecting at the upper ends of the pipes 11 and 13, 11′ and 13′, and 11″ and 13″ passes through the respective foam pipes 15, 15′ and 15″ into the waste pipe 17. Water condensing in the foam pipes 15, 15′ and 15″ will drop down under the influence of gravity to enter the water flow for continued processing through the apparatus 10.

Treated water then exits from the apparatus 10 through outlet 19. The treated water outlet 19 may be connected back to the inlet 14 for further treatment of water. Further foam from the waste outlet 17 may be passed to a settling tank where water condensing foam the foam may be further treated by being fed back to the inlet 14. Whilst the waste outlet pipe 17 is shown to be inclined upwardly, it may be inclined downwardly as shown in dotted outline in FIG. 3 from the first foam pipe 15.

To provide access to the upper ends of the respective pipes 11 and 13, 11′ and 13′, and 1″ and 13″, inspection ports 20, 20′ and 20″ may be provided, the ports 20, 20′ and 20″ having removable caps 21, 21′ and 21″ which allows for cleaning of the pipes 11 and 13 and insertion or removal of the gas outlets such as air stones.

The outlet 19 from the apparatus 10 may be connected to a screen filter such as a drum filter for filtering solids in the water. The outlet 19 alternatively or additionally may be connected to an UV treatment unit in the form of a pipe 22 (shown in dotted outline in FIG. 3) which houses an elongated ultraviolet lamp 23. Thus water flowing from the outlet 19 is subject to ultraviolet light to kill pathogens in the water.

Referring now to FIG. 6, there is illustrated a further embodiment of water treatment apparatus 24 according to the invention in which like components to the components of FIGS. 1 to 5 have been given like numerals. In this case however, four sets of pipes 11 and 13 corresponding to the pipes 11 and 13, 11′ and 13′ or 11″ and 13″ of the embodiment of FIG. 1 are provided, the pipe sets being arranged in a square plan configuration. The pipe sets 11 and 13 are connected in series with the common waste line 17 which follows the periphery of the separator but arranged in a transverse configuration.

As in the embodiment of FIG. 1 to 5, in use ozone is supplied to the lower ends of the pipes 13 to pass as bubbles through water flowing down the pipes 13 whilst air is supplied to the lower ends of pipes 11 to bubble through the water flowing up the pipes 11.

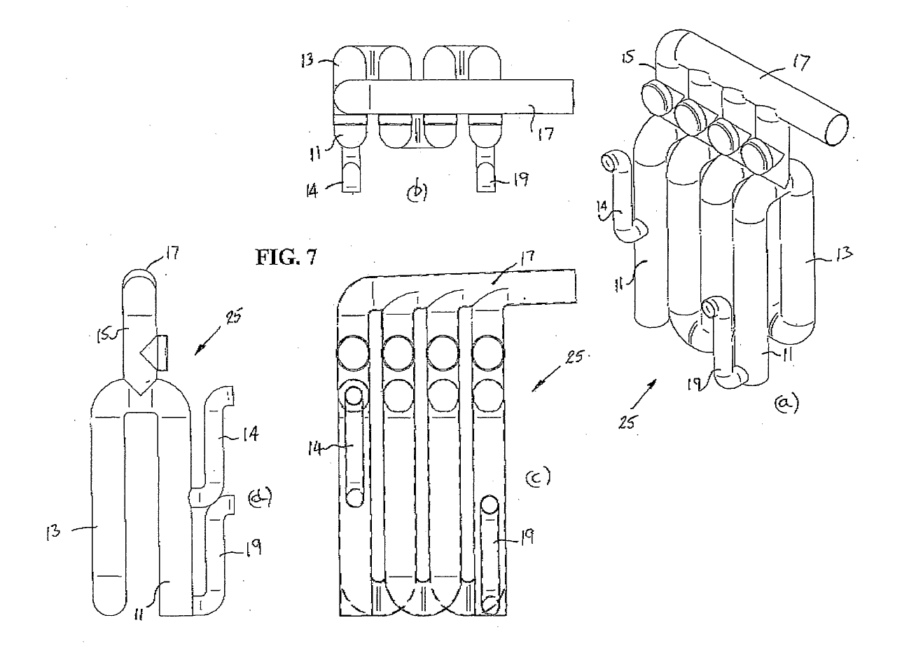

FIG. 7 illustrates a further embodiment of apparatus 25 according to the invention again in which like components to the components of FIGS. 1 to 5 have been given like numerals. As with the embodiment of FIG. 6, four sets of pipes 11 and 13 corresponding to the pipes 11 and 13, 11′ and 13′ or 11″ and 13″ of the embodiment of FIG. 1 are provided, the pipe sets being arranged in a transverse attitude relative to the waste pipe 17. The pipe sets 11 and 13 are connected in series with the foam collection pipes 15 being connected to the common waste line 17.

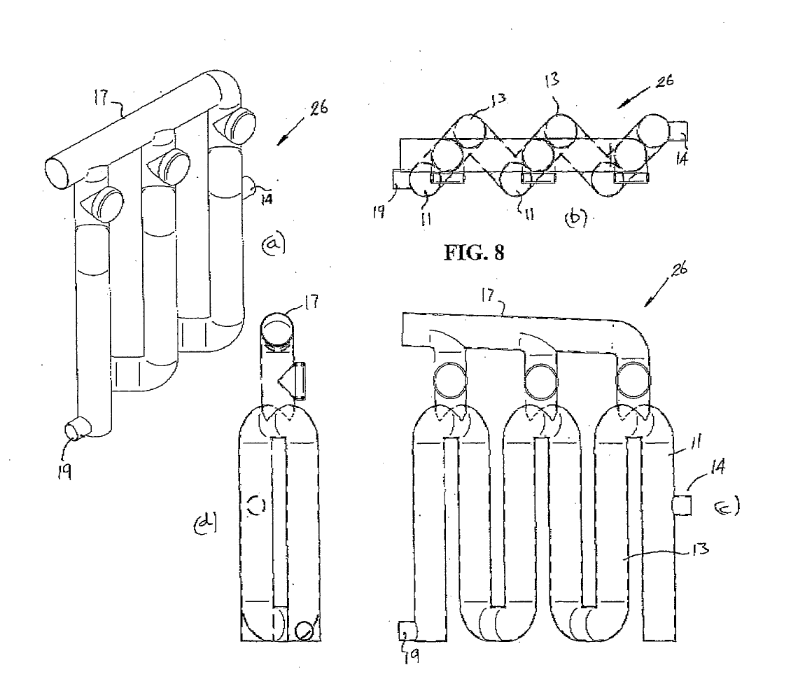

FIG. 8 illustrates a further embodiment of water treatment units 26 according to the invention again in which like components to the components of FIGS. 1 to 5 have been given like numerals. In this embodiment, three sets of pipes 11 and 13 corresponding to the pipes 11 and 13, 11′ and 13′ or 11″ and 13″ of the embodiment of FIG. 1 are provided, the pipe sets being arranged in a zig-zag configuration relative to the common waste pipe 17. The pipe sets 11 and 13 are connected in series with the foam collection pipes 15 being connected to the common waste line 17.

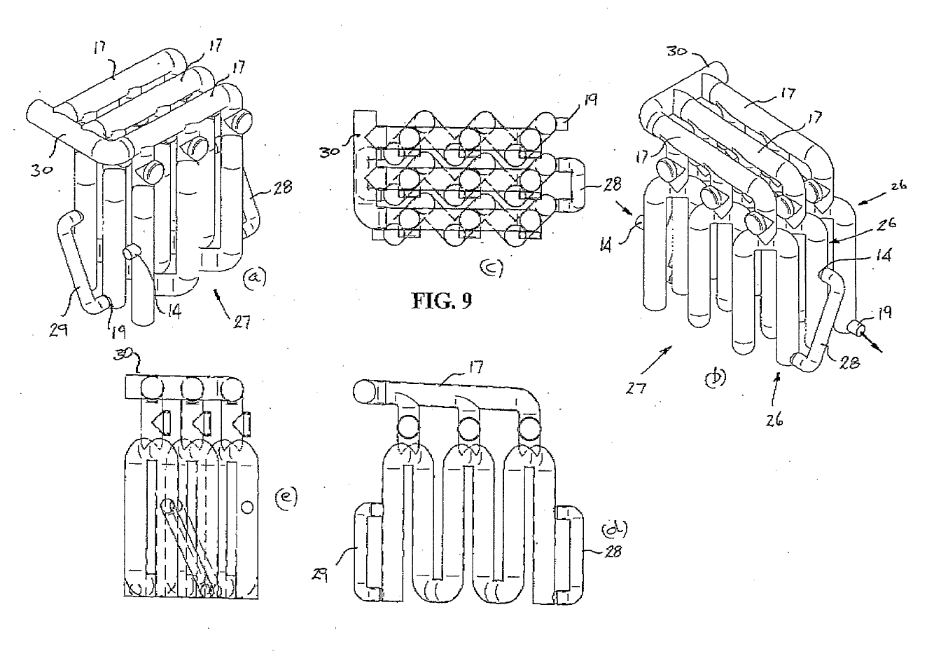

In the embodiment of FIG. 9, three water treatment units 26 of similar configuration to that of FIG. 8 are interconnected to provide the water treatment assembly 27. One unit 26 is provided with an inlet 14 for water to be treated at one end whilst its opposite end is connected through a connecting pipe 28 to the inlet 14 of an adjacent apparatus 26. The outlet 19 of the adjacent unit 26 is connected through connecting pipe 29 to the inlet of the trailing unit 26 which has the clean water outlet. In this case also the waste pipes 17 of each unit 26 are connected to a common waste pipe 30. It will be further noted in this embodiment that the waste pipes 17 are in an opposite inclination to their inclination shown in FIG. 8.

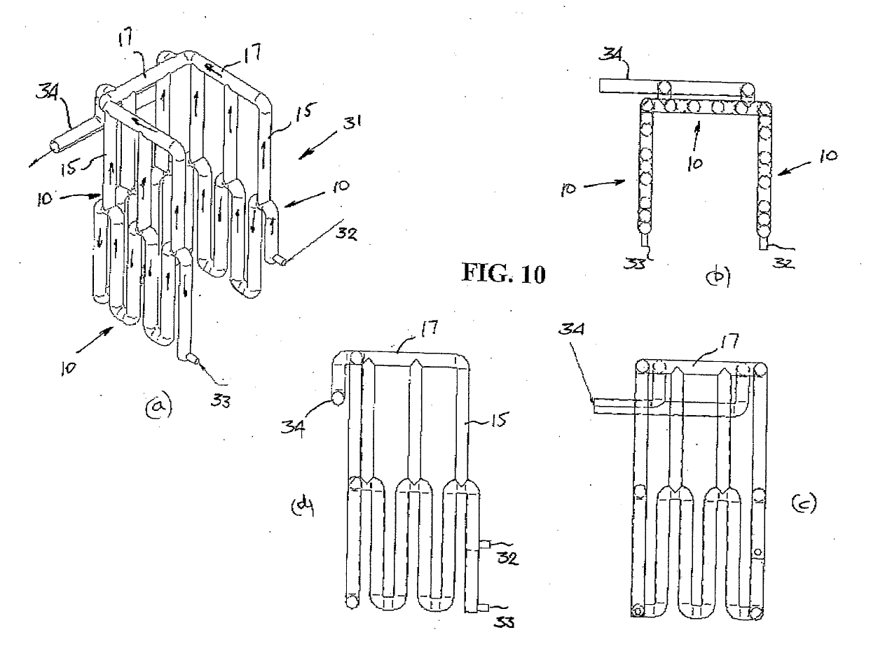

The water treatment apparatus 31 of FIG. 10 comprises three units 10 of the type illustrated in FIGS. 1 to 5, the units 10 being connected in series and arranged in this instance along the three sides of a square or rectangle. The three units 10 however may be arranged in a linear array. An inlet 32 for water to be treated (corresponding to the inlet 14) is provided to the pipe 11 of the leading unit 10 whilst an outlet 33 (corresponding to the outlet 19) is provided at the trailing end of the trailing unit 10. The waste pipes 17 of each unit 10 are interconnected at each corner of the assembly 31 and to a common waste outlet line 34 in this case, the foam collection pipes 115 of each unit 10 is of extended length.

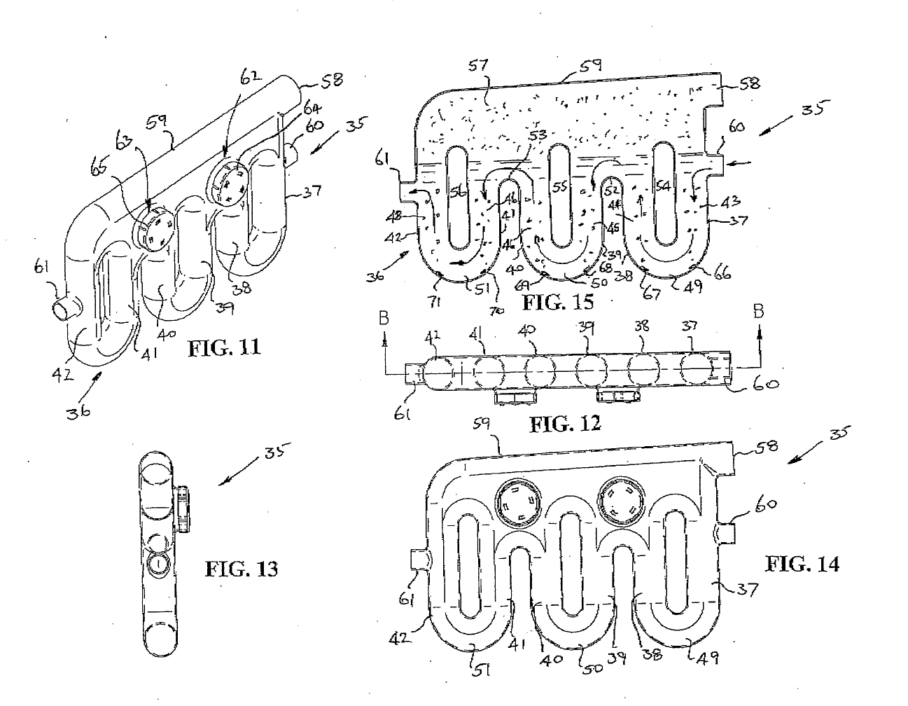

Referring now to FIGS. 11 to 15 there is illustrated an alternative water treatment apparatus 35 similar in principle to the embodiment of FIGS. 1 to 5. In this case however, the flow passages for water and foam are incorporated within a common integral housing 36. The housing has a series of duct-like members 37, 38, 39, 40, 41 and 42 of cylindrical cross section defining respective upright flow passages 43, 44, 45, 46, 47 and 48. The duct-like members 37 and 38, 39 and 40Q and 41 and 42 are joined by integral U-shaped members 49, 50 and 51 at their lower ends which essentially comprise curved extensions of the members 37 and 38, 39 and 40, and 41 and 42. The duct-like members 38 and 39, and 40 and 41 are joined on their adjacent sides and at their upper ends through integrally formed shoulders 52 and 53 which act as weirs over which water flows in use. The respective duct-like members 37 and 38, 39 and 40, and 41 and 42 are separated by voids 54, 55 and 56 which define one side of the respective members 37, 38, 39, 40, 41 and 42 extend above the level of the shoulders 52 and 53.

The housing 36 above the duct-like members 37 to 42 forms a hollow foam chamber 57 which has an outlet 58 for foam at one end. The chamber 57 has an upper wall 59 of a part-circular pipe-like cross section which extends to the outlet 58, the upper wall 59 being inclined slightly upwardly from the end of the separator 35 adjacent the duct-like member 42 to the outlet 58. Alternatively, the wall 59 may be horizontal or inclined downwardly from the member 42 to the outlet 58.

An inlet 60 for water to be treated is connected to the duct-like member 37 whilst an outlet 61 for treated water is connected to the duct-like member 48, the outlet 61 being below the inlet 60. Alternatively the inlet 60 and outlet 61 may be reversed.

A pair of ports 62 and 63 in to the chamber 57 for access to the interior of the housing 36 are provided between the duct-like members 38 and 39 and 40 and 41 respectively, the ports 62 and 63 being closable by respective internally threaded caps 64 and 65.

Gas outlets 66, 67, 68, 69, 70 and 71 are provided at the lower ends of the respective duct-like members 37, 38, 39, 40, 41 and 42. The gas outlets may be provided internally of the duct-like members for example in the form of air stones, perforated pipes or other outlets or may be external for example in the form of nozzles or venturis. The gas outlets 66, 68 and 70 are typically connected to a source of ozone whilst the gas outlets 67, 69 and 71 are typically connected to a pressurized air supply. The outlets however may be connected to other forms of gas supplies or to combined gas supplies for example to a mixed ozone/air supply. The ports 62 and 63 permit placement of the gas outlets into or removal from the housing 36.

In use, water to be treated is supplied through the inlet 60 to the apparatus 35 to flow through the respective flow passages 43, 44, 45, 46, 47 and 48 as indicated by the arrows in FIG. 15. Ozone supplied to the outlets 66, 68 and 70 bubbles through the water flowing through the passages 43, 45, and 47 in a direction opposite to water flow and creates a foam in the chamber 57 at the upper level of water in the passages, the foam carrying contaminants conveyed by the bubbles to the surface of the water. Air supplied to the outlets 67, 69 and 71 bubbles through the water flowing through the passages 44, 46 and 48 in the same direction as the water flow to assist in flow of water through the apparatus 35 and also carry contaminants in the water and create additional foam in the chamber 57. The foam collecting in the chamber 57 passes out through the outlet 58 to waste or for further treatment by for example condensing water from the foam and returning it to the inlet 60. Water passing through the apparatus 35 exits through outlet 61. Condensing water in the foam in the chamber 57 simply drops under the influence of gravity back into the passages 37, 38, 39, 40 and/or 41 for further treatment.

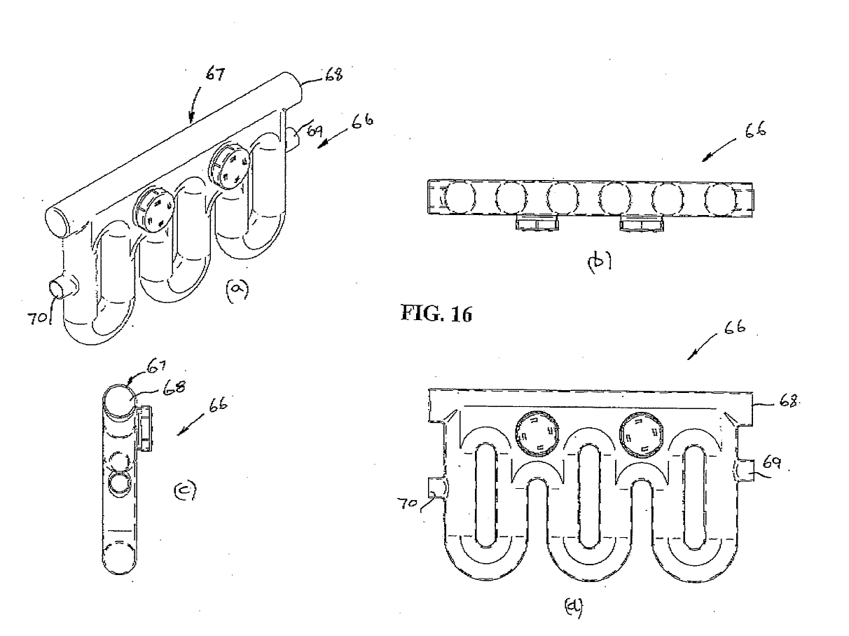

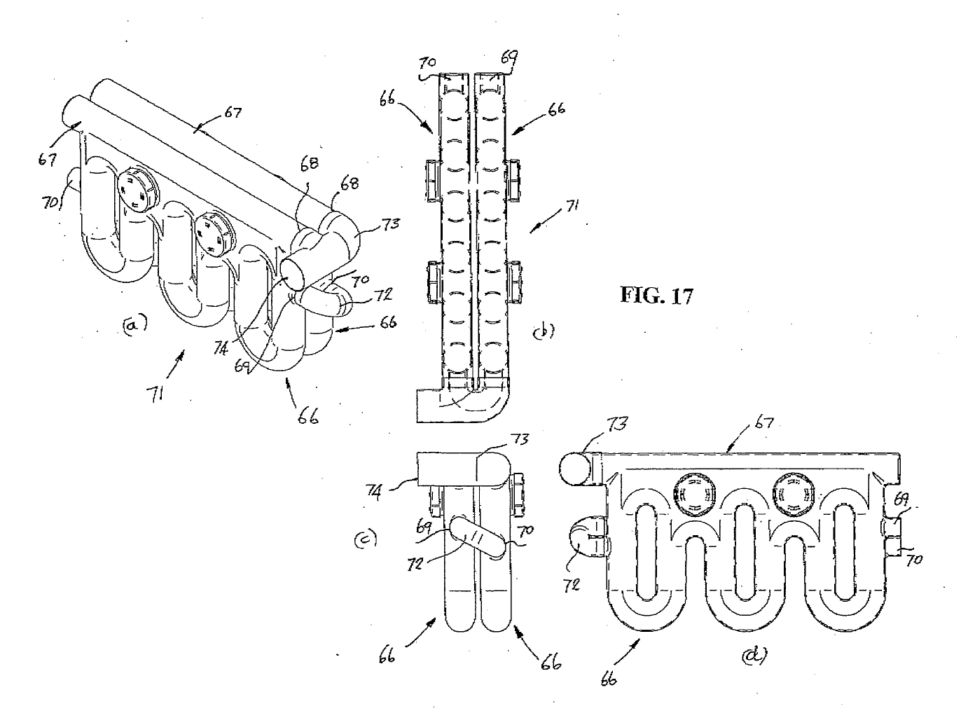

FIG. 16 illustrates a further embodiment of water treatment apparatus 66 which is similar to the embodiment of FIGS. 11 to 15 however in this case the foam collection chamber (equivalent to the chamber 57) includes an integrally formed part tubular member 67 which has an outlet 68 at one end and which in use lies in a substantially horizontal plane. As in the embodiment of FIGS. 11 to 15, the apparatus 66 has an inlet 69 at one end and an outlet 70 at the opposite end. The inlet and outlet however may be reversed from that shown in the drawings.

The combined water treatment apparatus 71 of FIG. 17 includes a pair of apparatuses 66 of the type shown in FIG. 17 arranged in a back-to-back juxtaposed relationship with the outlet 70 of one apparatus 66 being connected through a connecting duct 72 to the inlet 69 of the other apparatus 66. Thus water connected to the inlet 69 of the one apparatus 66 is processed by both apparatuses 66 before passing out of the outlet 70 of the other apparatus 66.

In addition, the duct-like foam collection chamber 67 have their outlets 68 interconnected by a joiner 73 having a single outlet 74 for foam carrying impurities extracted from the water flowing through the apparatus 66.

Although the embodiment of FIG. 17 includes two apparatuses 66, it will be appreciated that any number of apparatuses 66 may be connected in series and arranged in any orientation relative to each other.

Any of the water treatment units or apparatuses of the above described embodiments may be associated with further water treatment apparatus such as a UV water treatment chamber as described above or with further filtering apparatus such as a drum or screen filtering apparatus.

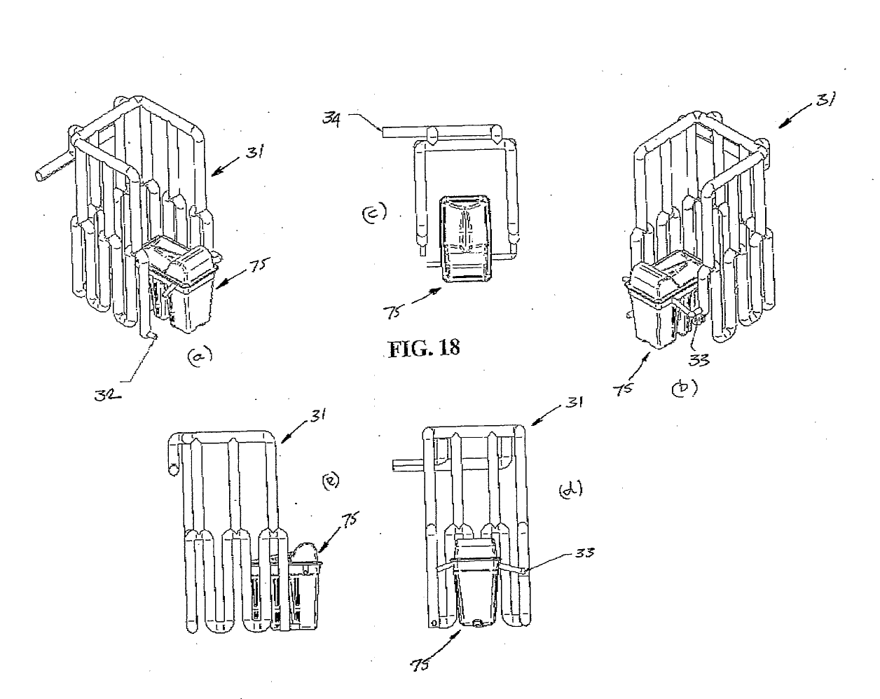

As an example FIG. 18 illustrates water treatment apparatus 31 similar to the type illustrated in FIG. 10 having its outlet 33 connected to a modular water treatment unit 75 of the type disclosed in our International Patent Application No. PCT/AU2006/000729. It will be noted in this case that the outlet and inlet have been reversed from that shown in FIG. 10 however the inlet and outlet of the apparatus 31 may be as shown in FIG. 10. The unit 75 includes a drum filter for removal of particulate matter in the water exiting the apparatus 31.

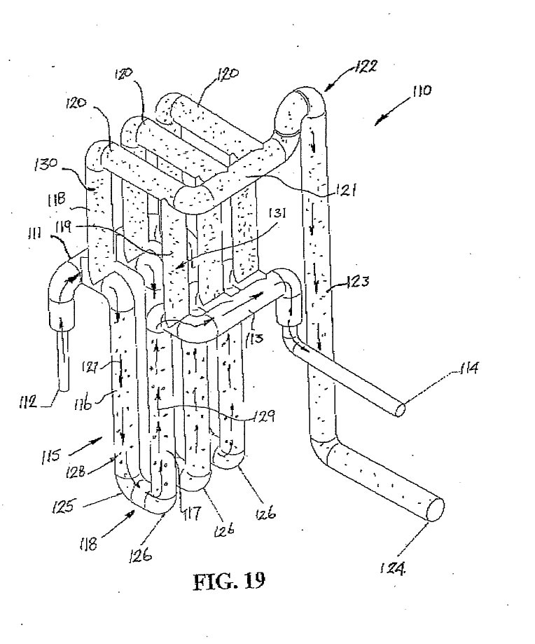

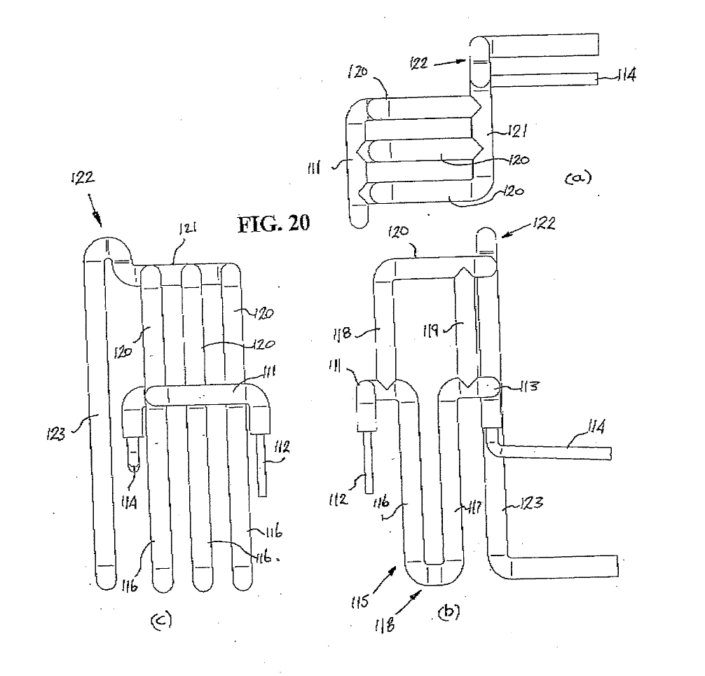

Referring now to FIGS. 19 and 20, there is illustrated a water treatment apparatus 110 according to an embodiment of the invention typically for treating contaminated water such as grey water, or water from a vehicle washing establishment or for treating any other water. The apparatus 110 includes an inlet manifold 111 in the form of a pipe-like member having an inlet 112 at one end for water to be treated an outlet manifold 113 having a water outlet 114 at one end for treated water. Extending between the inlet manifold 111 and outlet manifold 113 are a series of U-shaped foam units 115 which are connected in parallel between the inlet manifold 111 and outlet manifold 113. The units 115 each comprise a first upright pipe 116 which is connected at its lower end through a U-connector or alternative connector 117 to a second upright pipe 118, the pipes 116 and 117 being substantially parallel to each other A first upright foam collecting pipe 119 is connected to the upper end of the first pipe 116 adjacent or at its connection to the manifold 111 and a second upright foam collecting pipe 120 is connected to the upper end of the second pipe 117 at or adjacent its connection to the manifold 113. Substantially parallel connecting pipes 120 are connected to the upper ends of the foam collecting pipes 118 and 119 and to a common foam collection manifold 121 which extends transversely to the pipes 118 and 119 and which is also substantially horizontal. The foam collection manifold 121 is connected through an upwardly directed U-shaped trap 122 to a waste pipe 123 which extends substantially vertically downwardly from the trap 122 and which has a waste outlet 124

Gas outlets 125 and 126 are provided at the lower ends of the respective pipes 116 and 117. In this embodiment, the outlets 125 and 126 are connected to a source of ozone or ozone rich air. The ozone or ozone/air mixture may be supplied by an, ozone or air/ozone pump. The gas outlets 125 and 126 may be in the form of nozzles, or other outlets which penetrate the pipes or connector 118 or air stones, perforated or permeable members or other forms of outlets internally of and at the lower ends of the pipes 116 and 117.

In use water to be treated is supplied to the inlet 112 for flow into the manifold 111 and be directed to each of the parallel pipes 116 through which it flows in the direction indicated by the arrows 127 in FIG. 1. Water flows downwardly through the pipe 116 and then upwardly through the pipe 117 as indicated by the arrows 129. Ozone or an air/ozone mixture supplied to the gas outlet 125 bubbles upwardly through the water flowing downwardly through the pipe 116 so that water flowing therein is exposed to the sterilizing effect of ozone. Bubbles of gas reaching the upper end of the pipe 116 create a foam which carries contaminants in the water. The foam 130 will pass upwardly through the foam-collecting pipe 118 into the manifold 121 via the connecting pipe 120.

Ozone or an ozone/air mixture supplied to the outlet 126 bubbles through the water flowing in the pipe 117 in the same direction as the water flow. This assists in the water flow through the pipe 117 using an air lift or venturi effect as well as removing contaminants in the water which creates further foam at the upper end of the pipe 117. The further foam 131 passes upwardly through the pipe 119 into the manifold 121. Foam is thus created by each of the three units 115 arranged in parallel as water flows in a serpentine manner through the respective units 115.

Foam collecting in the manifold 121 passes through the inverted U-shaped trap 122 to the waste line 123 where it is directed to waste though the outlet 124 or which may be further processed. The trap 122 ensures that water condensing out of the foam in the manifold 121 does not pass to waste but will flow downwardly under the influence of gravity for further processing by the units 115.

Treated water received in the outlet manifold 113 from each water treatment unit 115 exits from the water treatment apparatus 110 through outlet 114. The treated water outlet 114 may be connected back to the inlet 112 for further treatment of water. Further foam from the waste outlet 124 may be passed to a settling or swirl tank or chamber where water condensing from the foam may be father treated by being fed back to the inlet 112.

The outlet 114 from the water treatment apparatus 110 may be connected to a screen filter such as a drum filter for filtering solids in the water. The outlet 119 alternatively or additionally may be connected to an UV treatment unit to kill pathogens in the water.

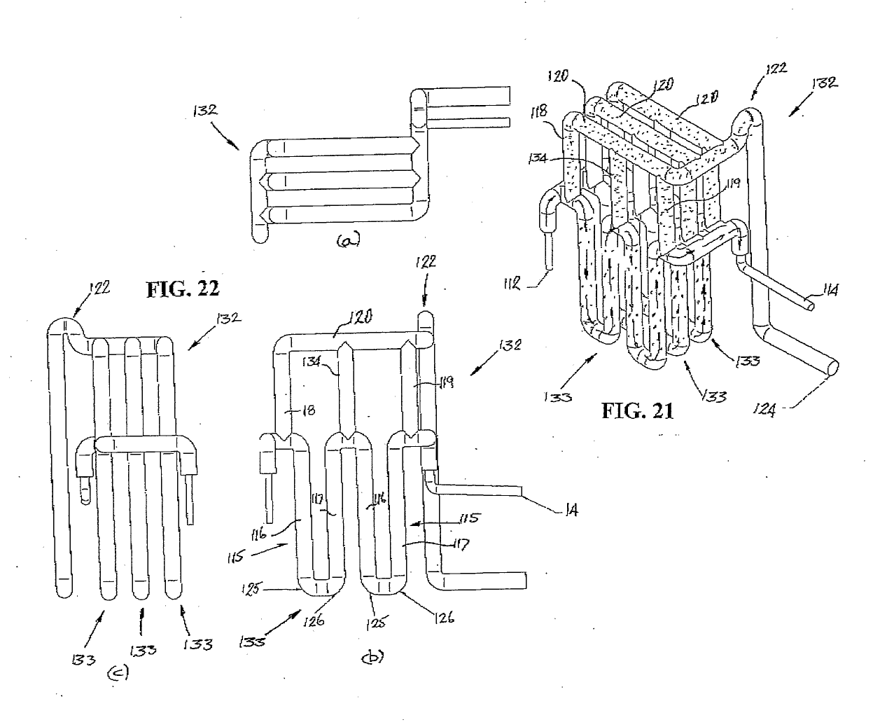

Referring now to FIGS. 21 and 22, there is illustrated a further embodiment of water treatment unit or separator assembly 132 according to the invention in which like components to the components of the water treatment apparatus 110 of FIGS. 19 and 20 have been given like numerals. The water treatment apparatus 132 as in the embodiment of FIGS. 19 and 20 has a bank of three treatment units 133. Each water treatment unit 133 however comprises a pair of units 115 of the type illustrated in FIG. 19 arranged in series with the upper end of the pipe 117 of one of the units being connected to the upper end of the pipe 116 of the adjacent water treatment unit 115. Furthermore, an additional upright foam collecting pipe 134 is connected at its lower end to the junction between adjacent pipes 116 and 117 and at its upper end to the connecting pipe 121 for connection to the common waste manifold. Gas outlets 125 and 126 are provided at the lower ends of the pipes 116 and 117 of each water treatment unit 115 such that bubbles of ozone or ozone/air pass upwardly through the pipes 116 and 117 with the ozone or ozone/air flowing upwardly against the water flow downwardly through the pipes 116 and upwardly with water flow upwardly through the pipes 117 to create foam at the upper ends of the pipes 116 and 117 which passes into the pipes 118, 119 and 134.

As in the embodiment of FIGS. 19 and 20, in use ozone is supplied to the lower ends of the pipes 113 to pass as bubbles through water flowing down the pipes 116 whilst air is supplied to the lower ends of pipes 117 to bubble through the water flowing tip the pipes 17.

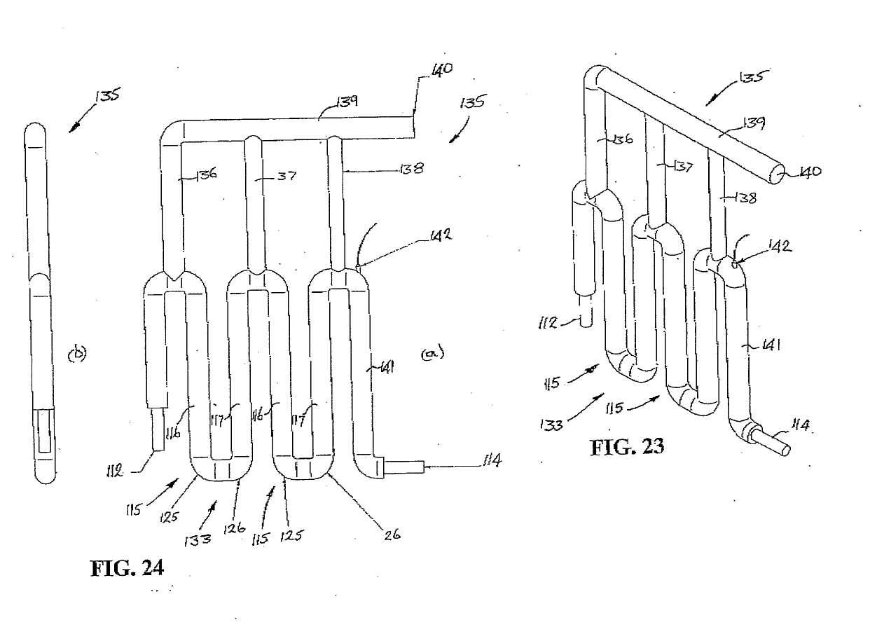

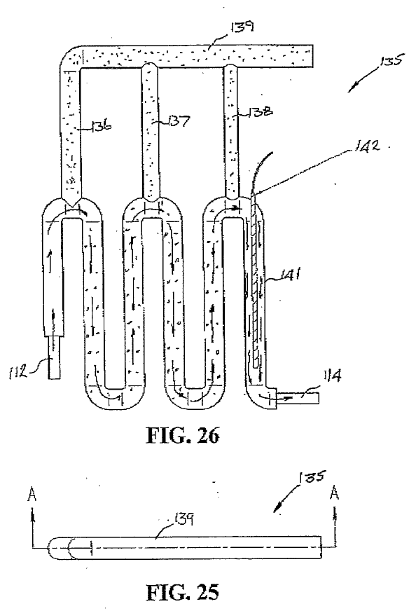

FIGS. 23 to 26 illustrate a water treatment unit 135 similar to the apparatus 133 used in the water treatment apparatus 122 of the embodiment of FIGS. 21 and 22 and comprising a pair of units 115 arranged in series. Like components to the water treatment unit 115 shown in FIGS. 19 to 21 have been given like numerals. In this case, the upright foam collecting pipes 136, 137 and 138 corresponding to the foam collecting pipes 118, 134 and 119 are connected at their upper ends to a common waste pipe 139 in which foam is collected, the pipe 139 having a waste outlet 140. The foam collecting pipe 136 has a greater diameter or cross sectional area than the pipe 137 and the pipe 137 has a greater diameter or cross sectional area than the pipe 138.

In addition, the trailing end of the water treatment unit 135 is connected to an upright pipe 141 through which an elongated ultraviolet lamp 142 extends substantially concentrically. Thus water from the apparatus 133 is exposed to ultraviolet light before exiting through the outlet 114.

The water treatment apparatus 135 described an illustrates in FIGS. 23 to 26 may be used in the water treatment apparatus 132 of FIGS. 21 and 22 with the outlet from each water treatment apparatus 135 being connected to a single ultraviolet treatment unit or to three separate ultraviolet treatment units similar to that described in FIGS. 23 to 26.

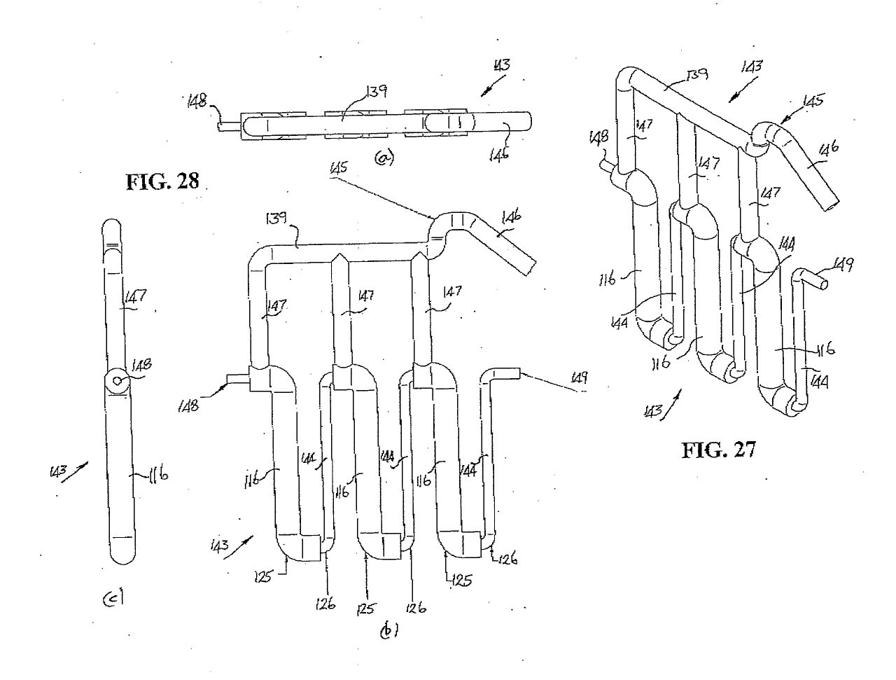

The embodiment of water treatment apparatus 143 of FIGS. 27 and 28 is similar to that of FIGS. 21 to 23 except that the pipes 144 corresponding to the pipes 117 of FIGS. 21 to 23 are of reduced diameter so that an increased air lift or venturi effect is achieved by gas such as ozone and/or air bubbling through the pipes 144. In addition, the foam waste pipe 139 is connected to a trap 145 similar to the trap 122 so that water condensing from the foam is not directed to waste but returns under the influence of gravity to the water treatment unit 144 for further processing. A downwardly inclined waste pipe 146 is connected to the outlet side of the trap 145. Upright foam collecting pipes 147 collect foam from the upper ends of the pipes 116 and 144 as in the previous embodiments which passes into the foam waste pipe 139 connected to the trap 145.

It will be further noted in this embodiment that the inlet 148 to the assembly 143 is located adjacent to the junction of the first pipe 116 and foam collection pipe 147 whilst the treated water outlet 149 is located at the upper end of the reduced diameter pipe 144 at the trailing end of the water treatment apparatus 143.

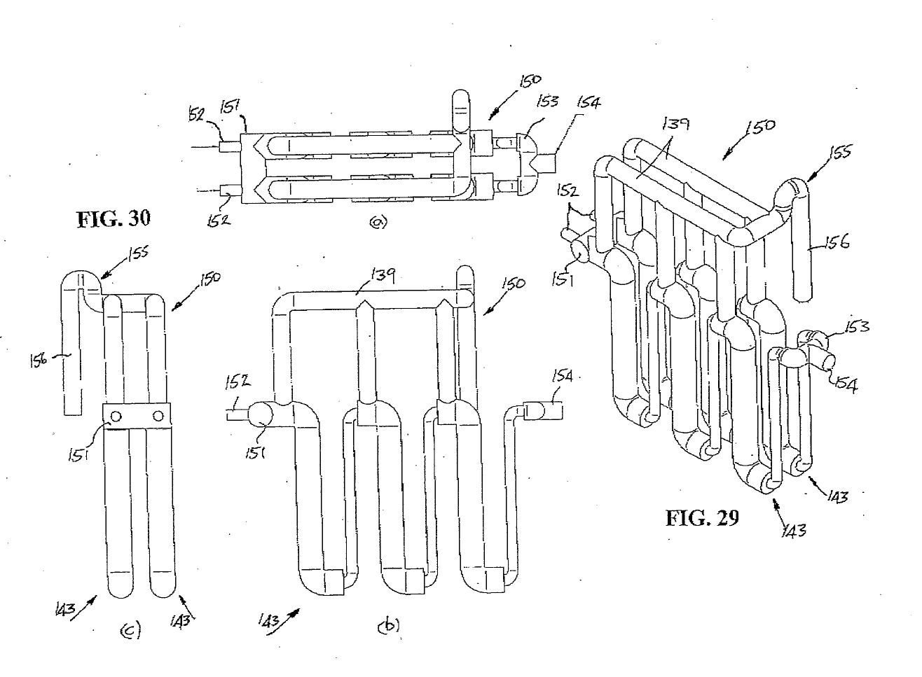

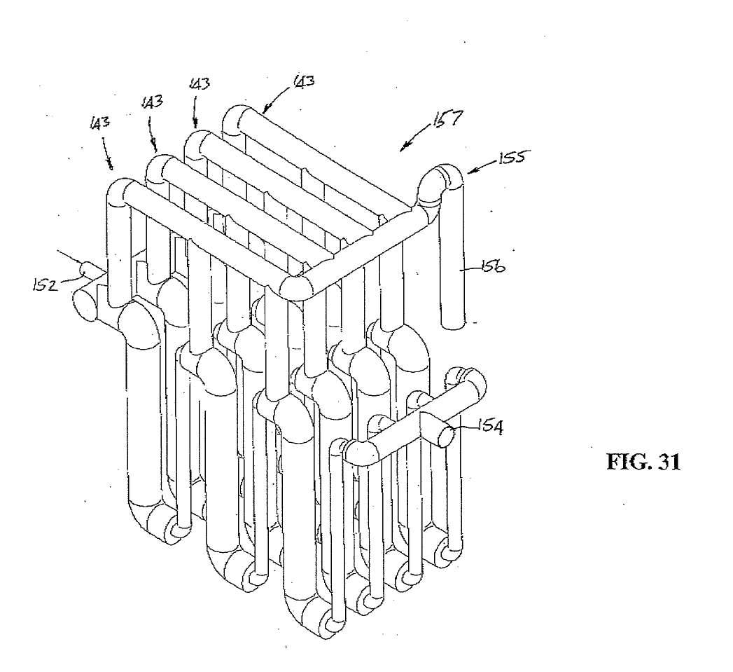

The water treatment apparatus 150 of FIGS. 29 and 30 comprises a pair of water treatment apparatuses 143 of the type shown in FIGS. 27 and 28 arranged in parallel and connected between an inlet manifold 151 having a pair of inlets 152 and outlet manifold 153 having a single water outlet 154. The inlets 152 however may be separate and connected to the respective assemblies 143. The foam waste pipes 139 are also connected through a single trap 155 to a downwardly directed outlet 156.

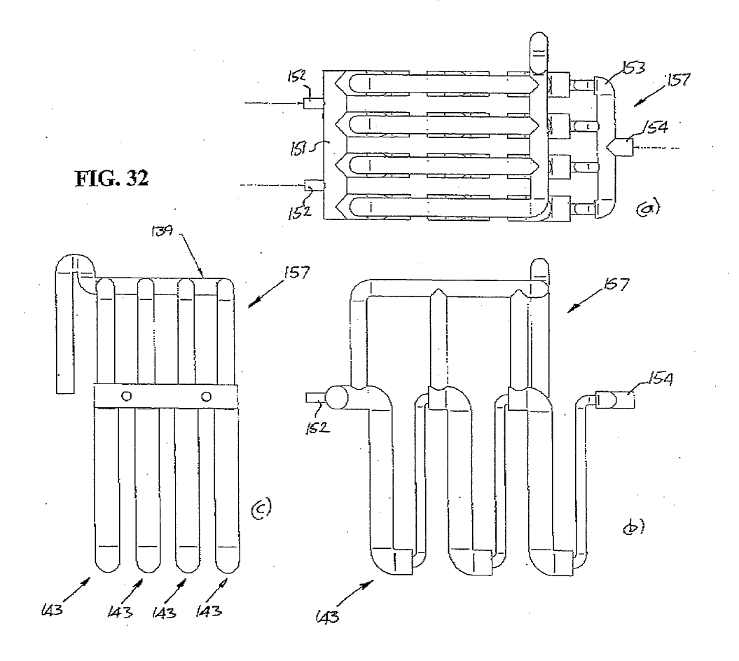

Of course any number of water treatment apparatuses 143 may be arranged in parallel as for example in the water treatment apparatuses 157 of FIGS. 31 and 32 which includes four such water treatment apparatuses 143 with a pair of inlets 152 and a single treated water outlet 154 and foam waste outlet 156.

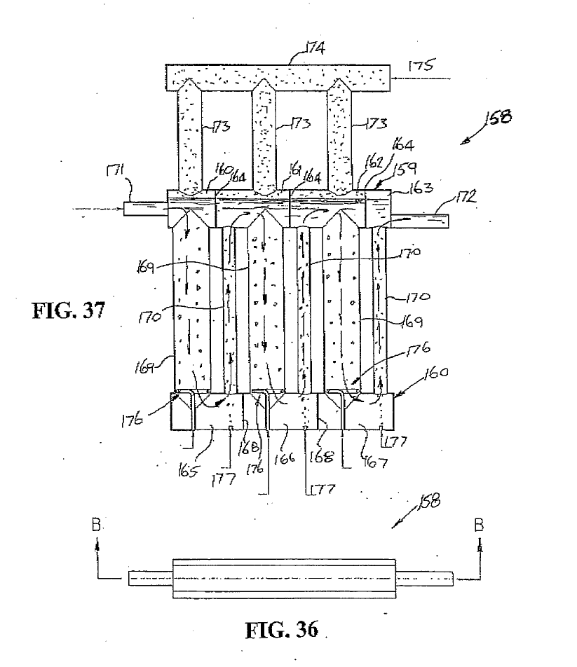

FIGS. 33 to 37 illustrates a further embodiment of water treatment unit 158 according to the present invention which is similar in principle to the embodiment of FIGS. 27 and 28. In this embodiment however, the water treatment apparatus 158 includes upper and lower manifolds 159 and 160, the manifold 159 being divided into four chambers 160, 161, 162 and 163 by respective transverse walls 164 spaced along the manifold 159. The manifold 159 typically is in the form of a tubular pipe of any cross section.

The lower manifold 160 is of a similar construction however in this instance, the manifold 160 is divided into three chambers 165, 166 and 167 by two transverse walls 168. As with the manifold 160, the manifold 160 typically is in the form of a tubular pipe of any cross section.

Pipes 169 extend between and are connected to the respective opposite chambers 160 and 165, 161 and 166 and 162 and 167. Pipes 170 of smaller diameter or cross sectional area than the pipe 169 extend between the respective opposite chambers 161 and 165, 162 and 166 and 163 and 167. An inlet 171 for water is connected to the chamber 160 whilst an outlet 172 for treated water is connected to the chamber 163. Upright foam collecting pipes 173 are connected at their lower ends to the respective chambers 160, 161 and 162 and connected at their upper ends to a foam waste pipe 174 having an outlet 175.

Gas outlets 176 in the form of permeable pipes are provided in the lower ends of the pipes 169 whilst gas inlets 177 are provided in the respective chambers 165, 166 and 167. The gas outlets 176 are connected in use to an ozone source whist the inlets 177 are connected to a source of air and/or ozone form for example an air or air/ozone pump. The inlets 177 are preferably arranged immediately below the pipes 170.

The water treatment unit 158 functions in the manner previously described with water enter ing the inlet 171 flowing in a serpentine manner as indicated by the arrows in FIG. 37 down the respective pipes 169 and up the smaller diameter pipes 170 and through the respective chambers 160, 161 and 162 and 165, 166 and 167 to the treated water outlet 172. Ozone from the outlets 176 passes as bubbles up the pipes 169 against the water flow creates a foam which collects in the pipes 173 and which is directed to the common foam waste pipe 174. Air or air/ozone entering the inlets 177 passes as bubbles up the pipes 170 to act as a venturi or air lift to assist in water flow upwardly through the pipes 170. This adds to the creation of foam at the upper level of water which passes into the pipes 173 and foam waste pipe 174.

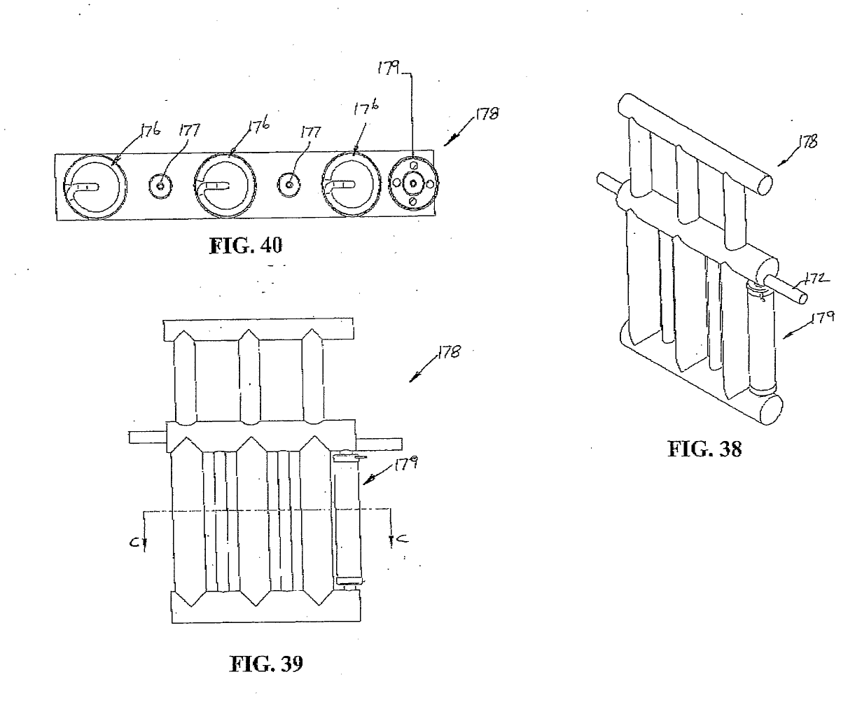

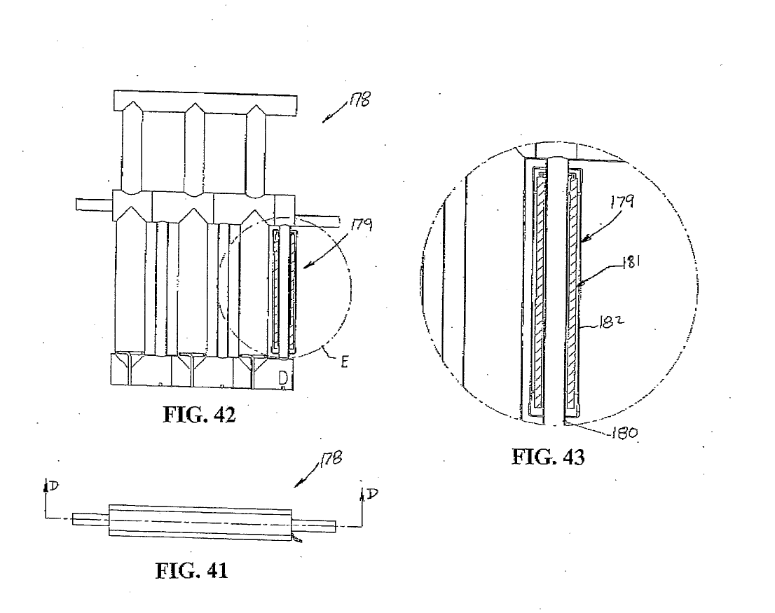

The embodiment of water treatment unit 78 of FIGS. 38 to 43 is similar to the embodiment of FIGS. 33 to 37 except that the final pipe 180 comprises a transparent pipe connected at opposite ends to the chambers 163 and 167, the pipe 180 being surrounded by four elongated ultraviolet lamps 181 which are spaced circumferentially around the pipe 180 and which are located within a housing 182 supported coaxially around the pipe 180.

In use, water flowing through the transparent pipe 180 is exposed to ultraviolet light from the lamps 181 before it passes out the outlet 172. Whilst the embodiment shows the use of four ultraviolet lamps 181 located around the pipe 180, any number of ultraviolet lamps 181 from one or more may be used. Typically the transparent pipe 180 comprises a clear plastics or glass pipe.

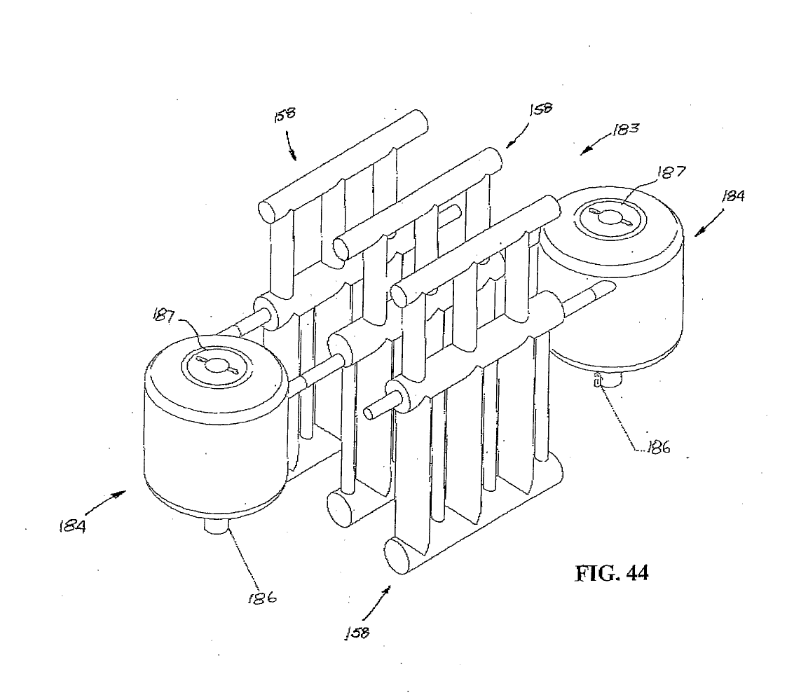

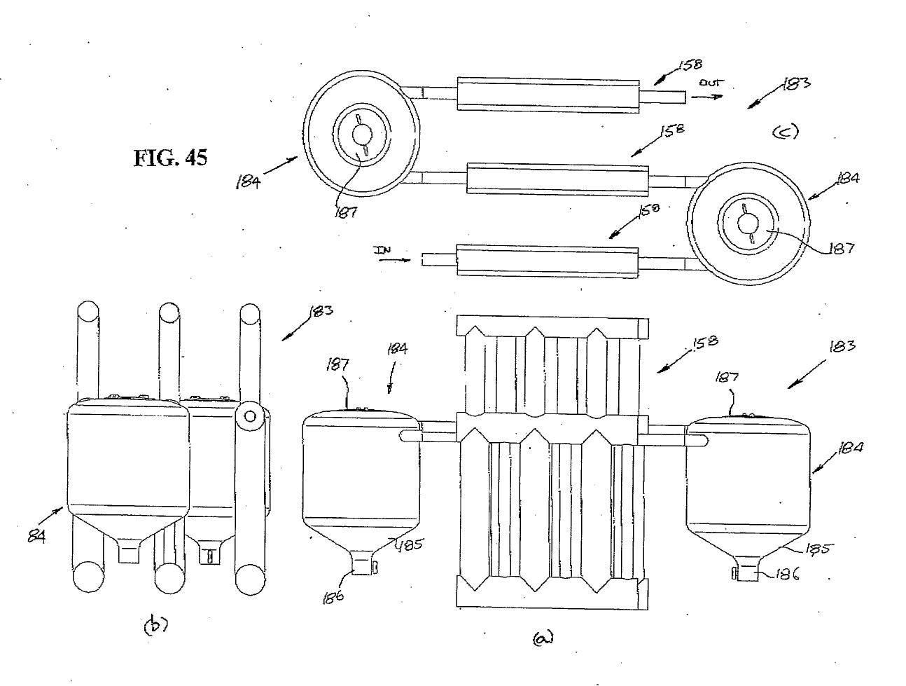

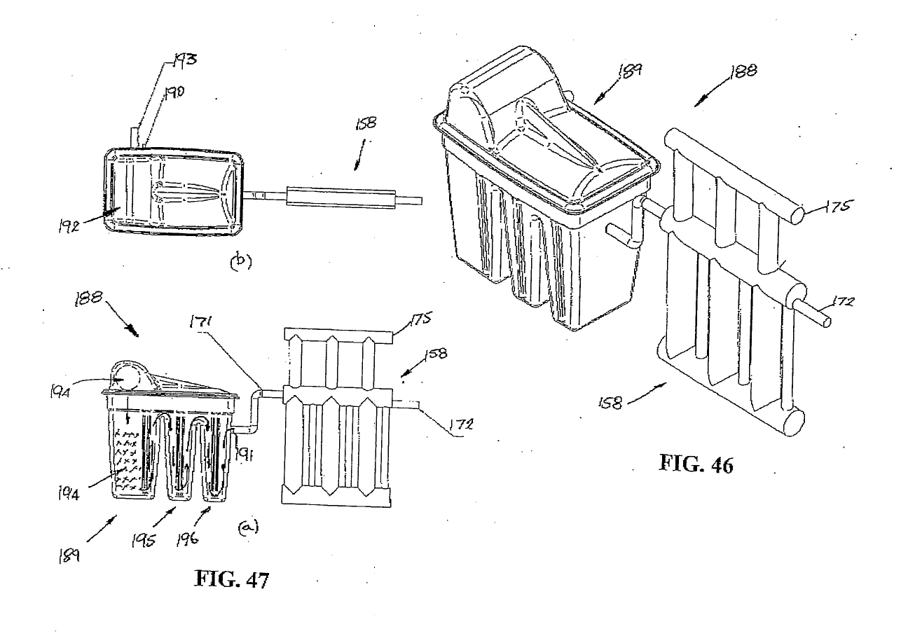

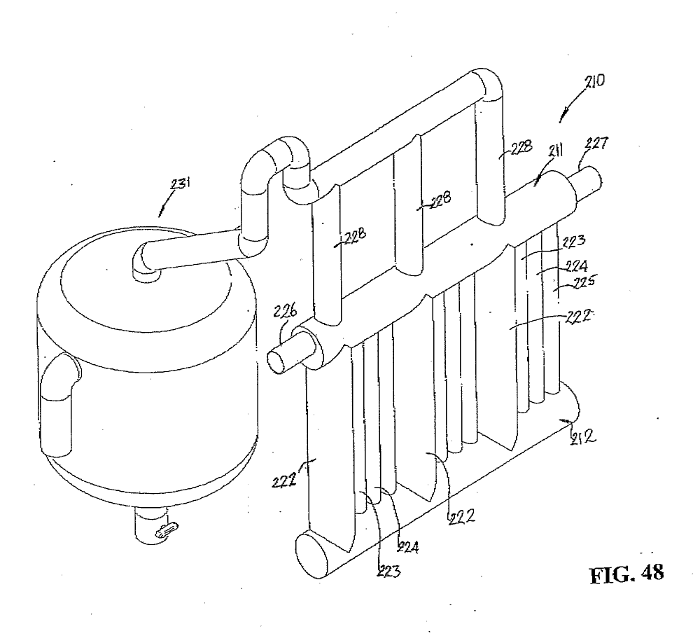

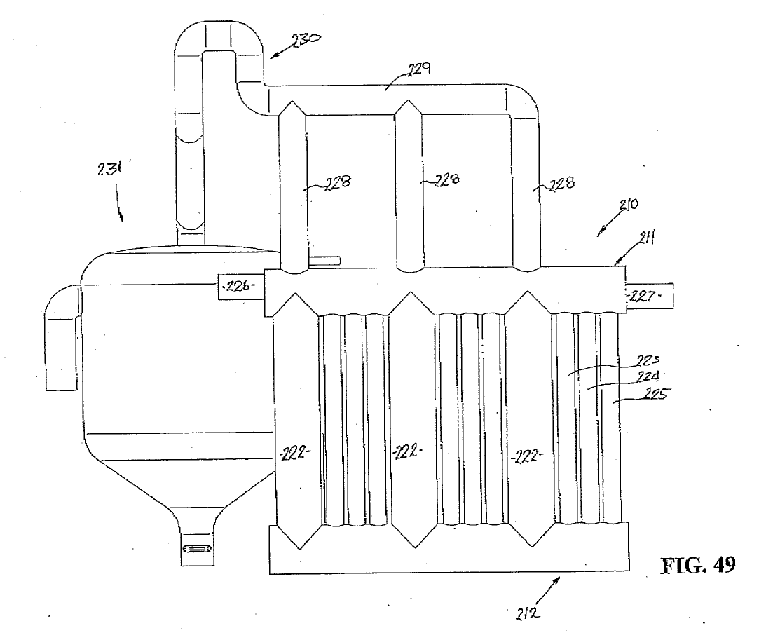

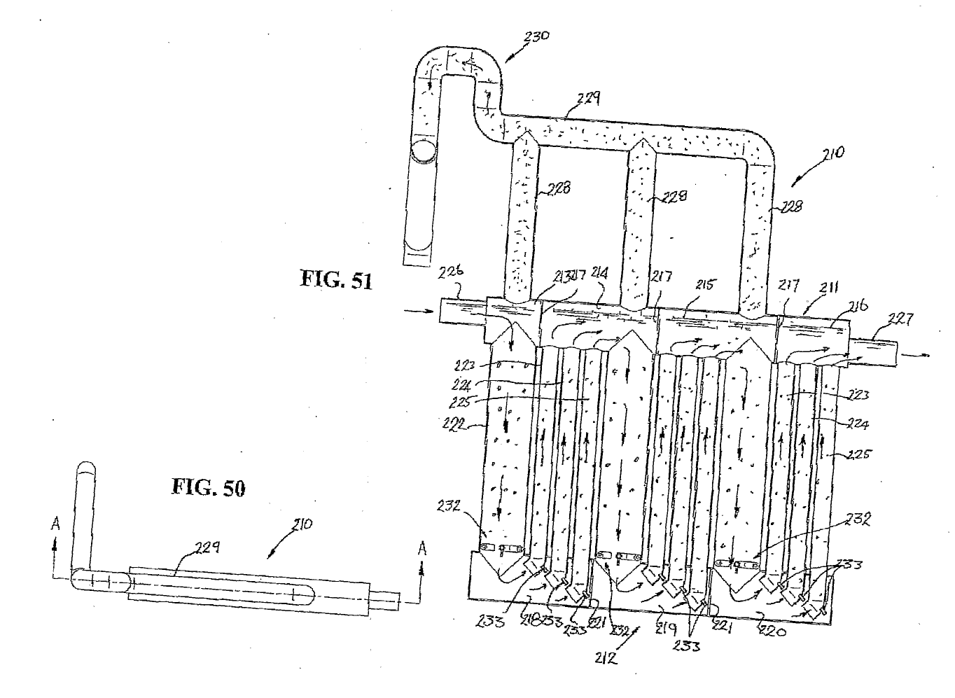

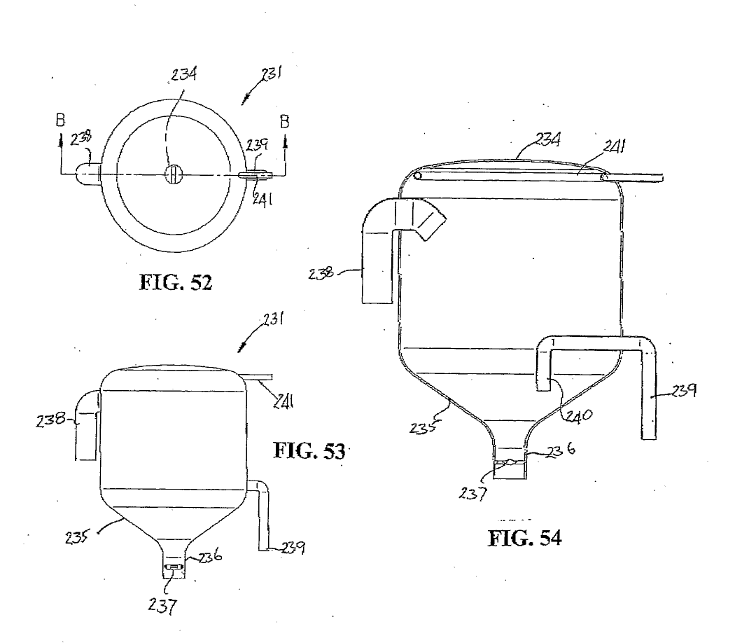

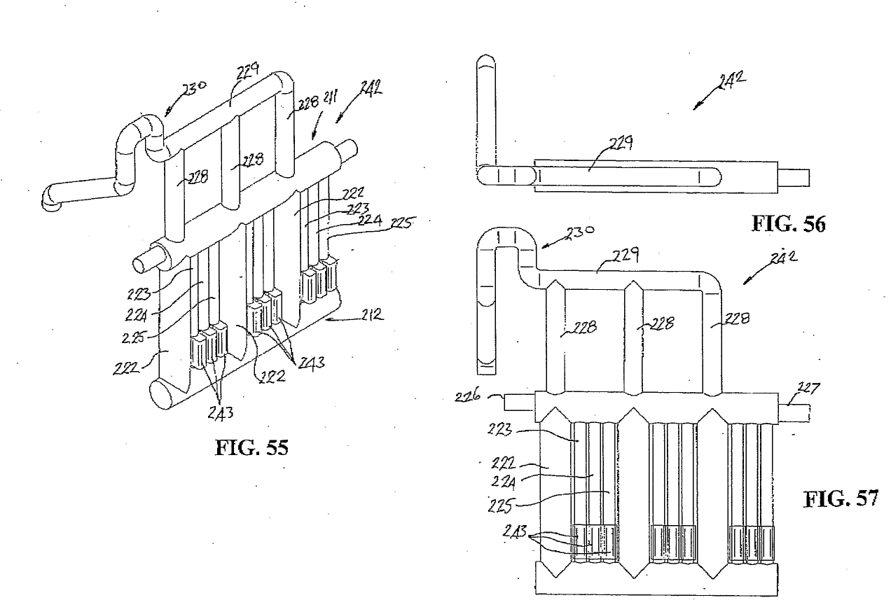

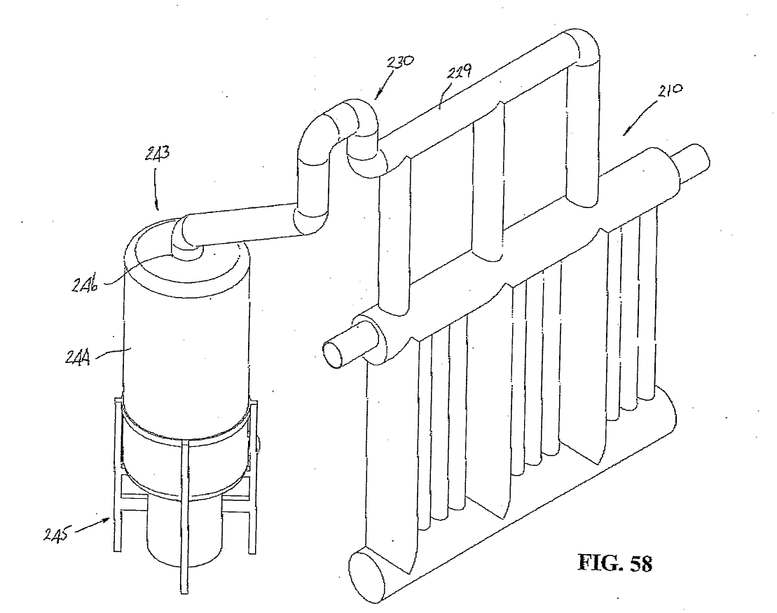

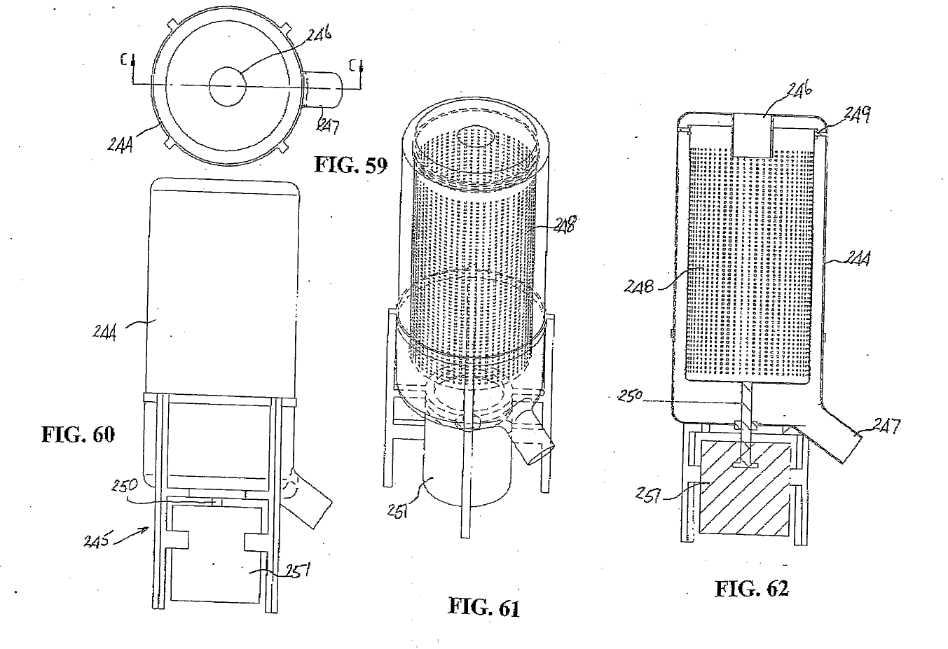

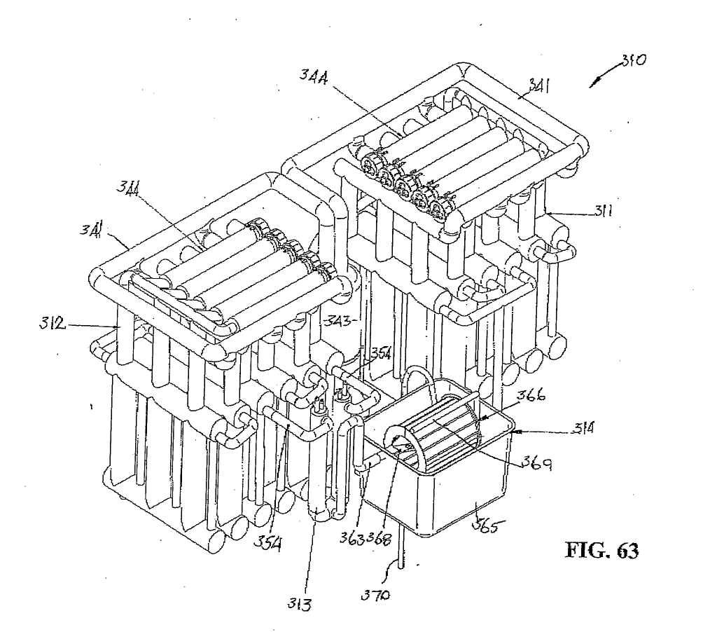

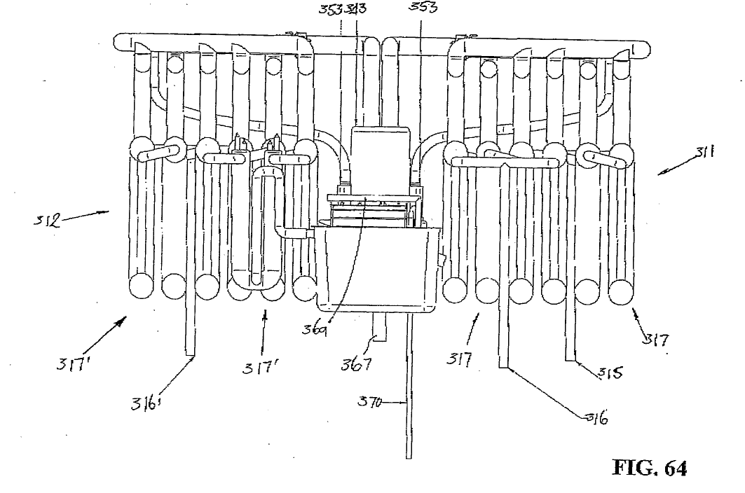

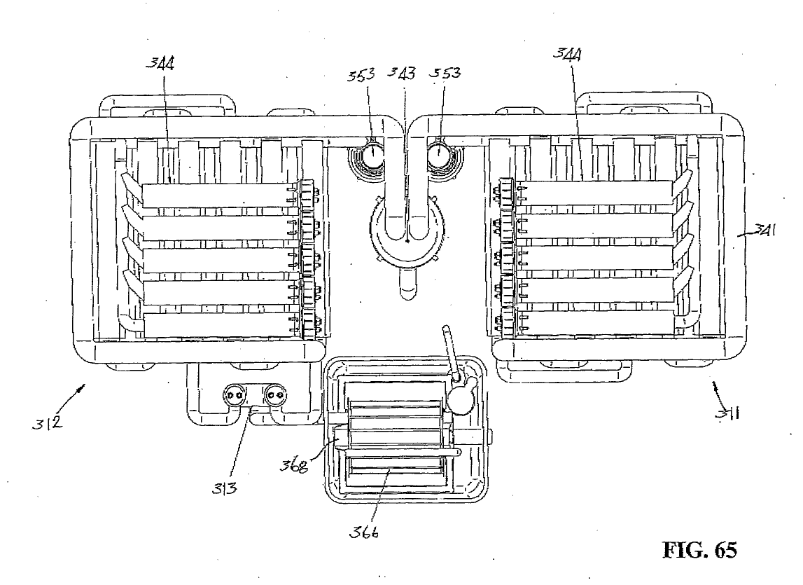

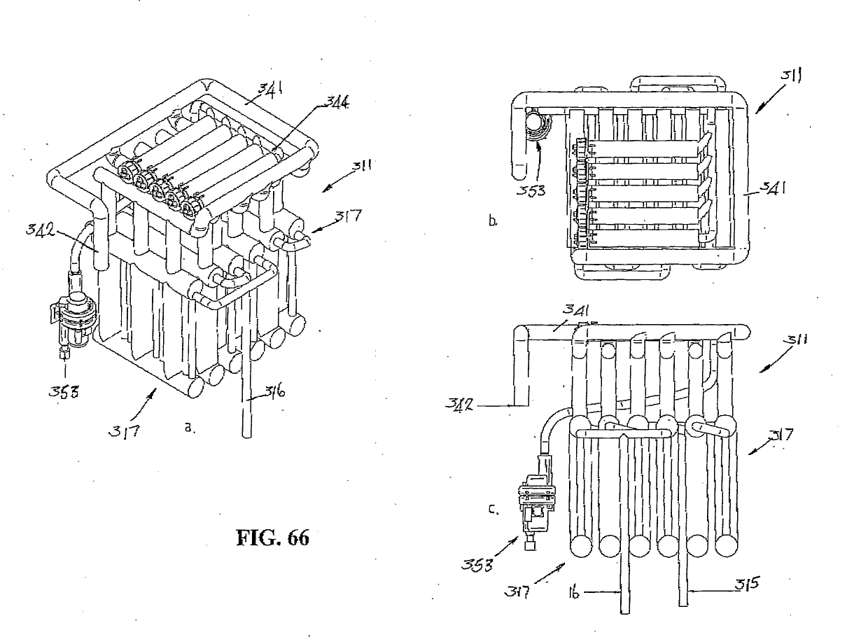

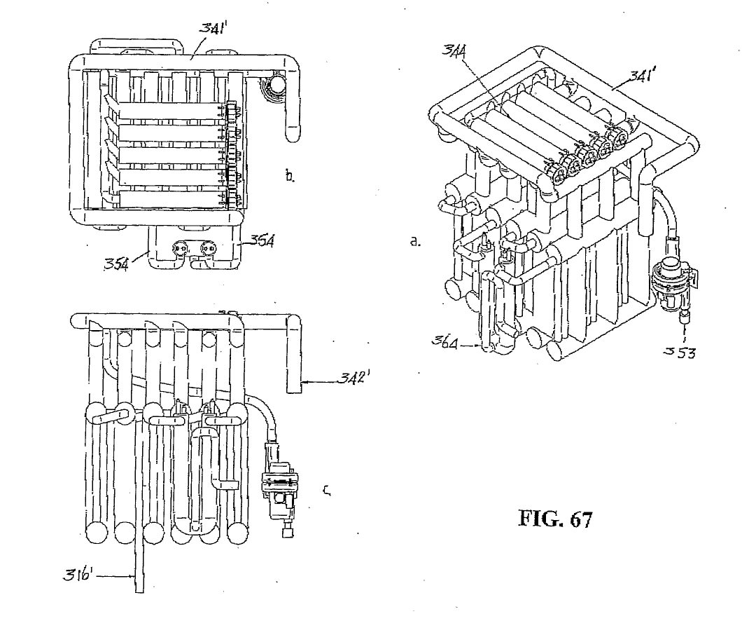

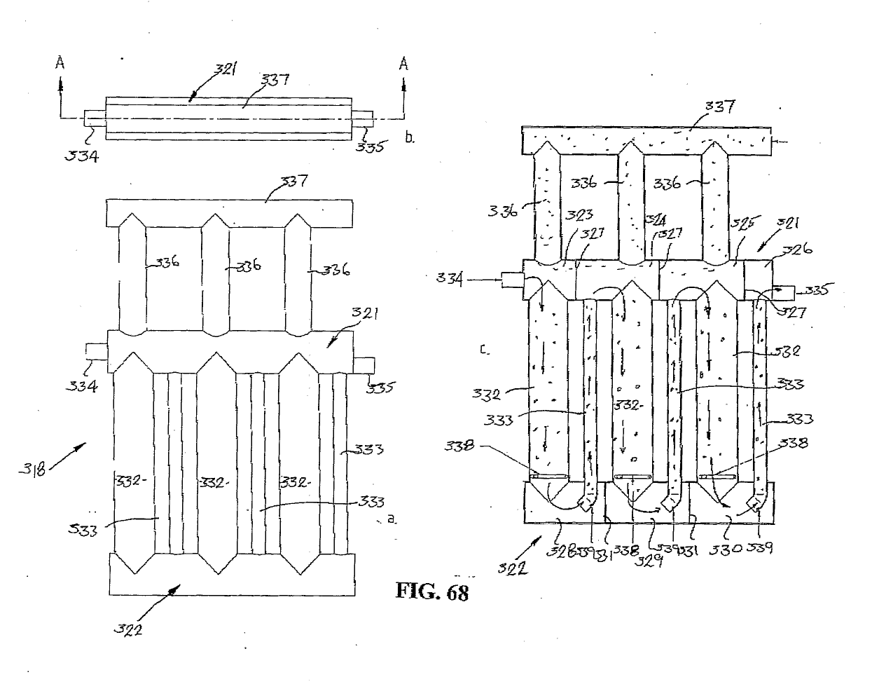

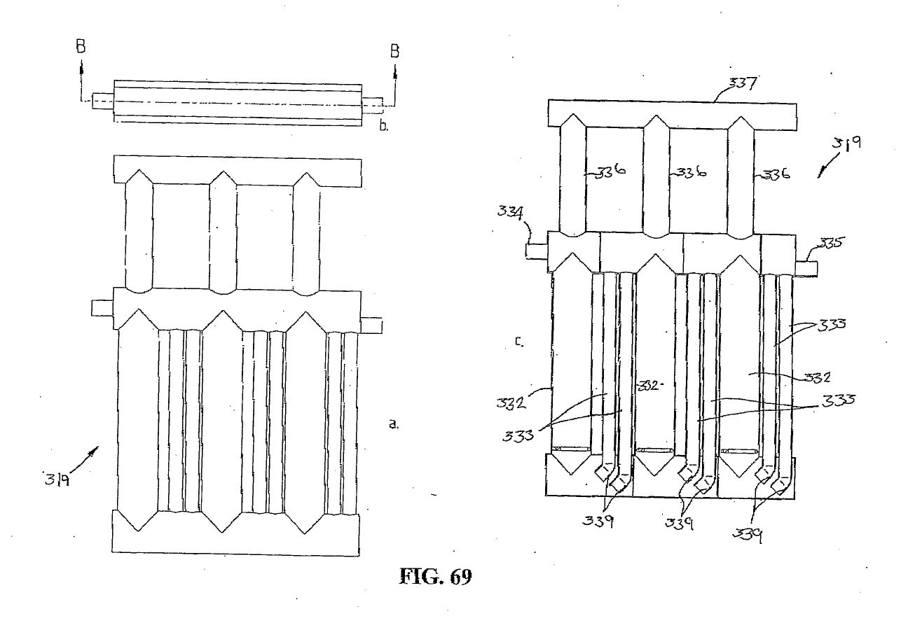

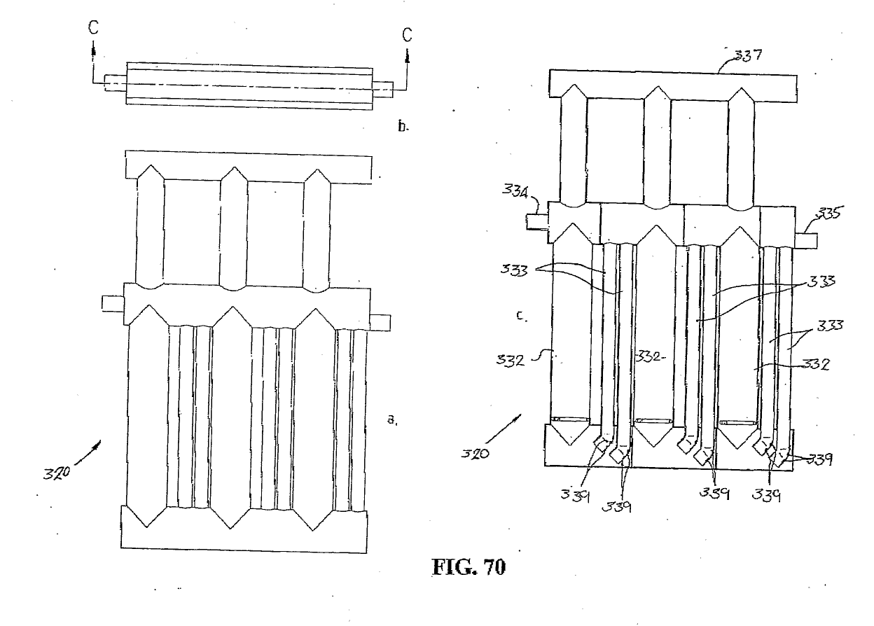

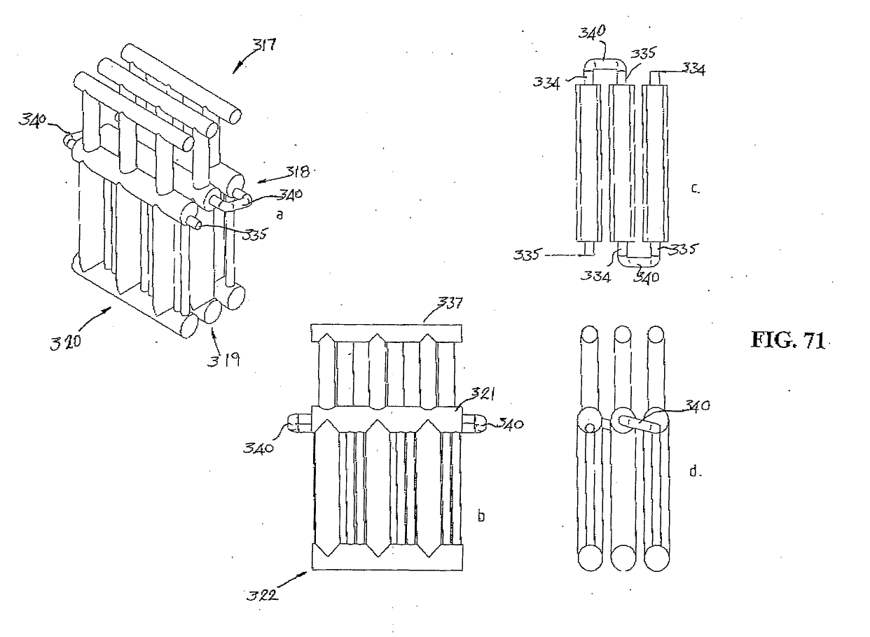

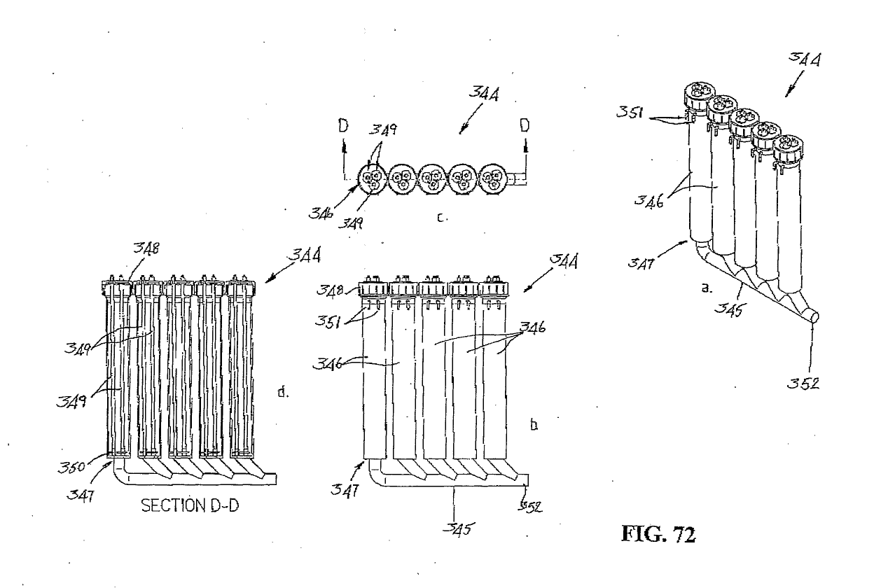

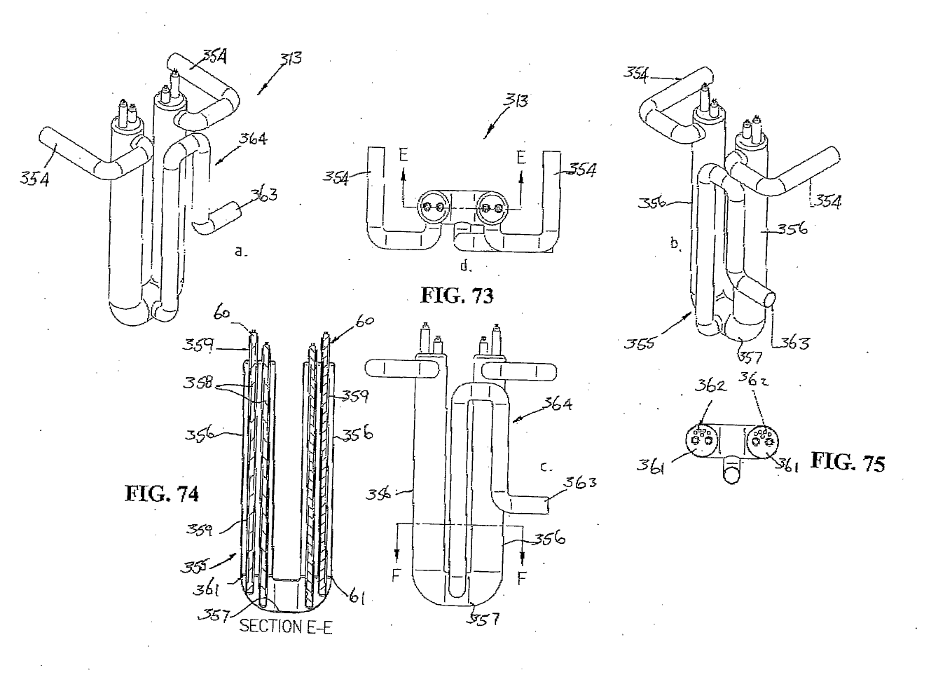

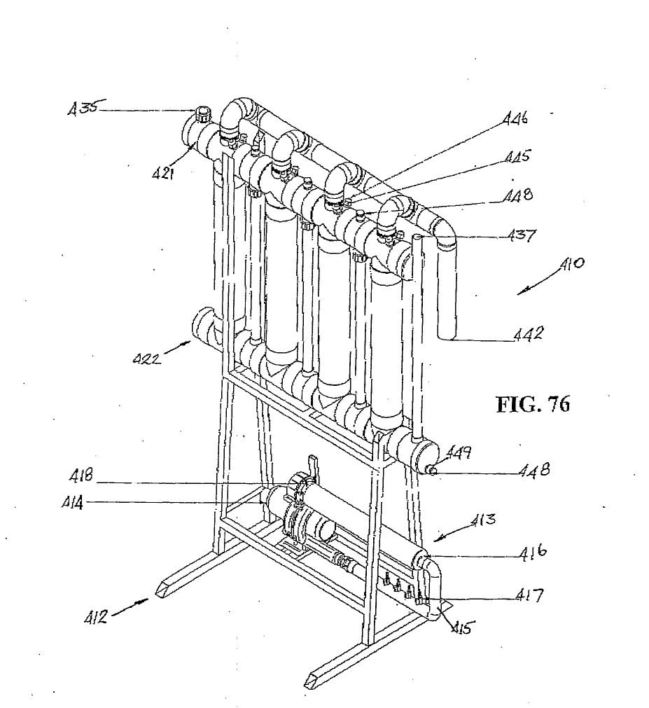

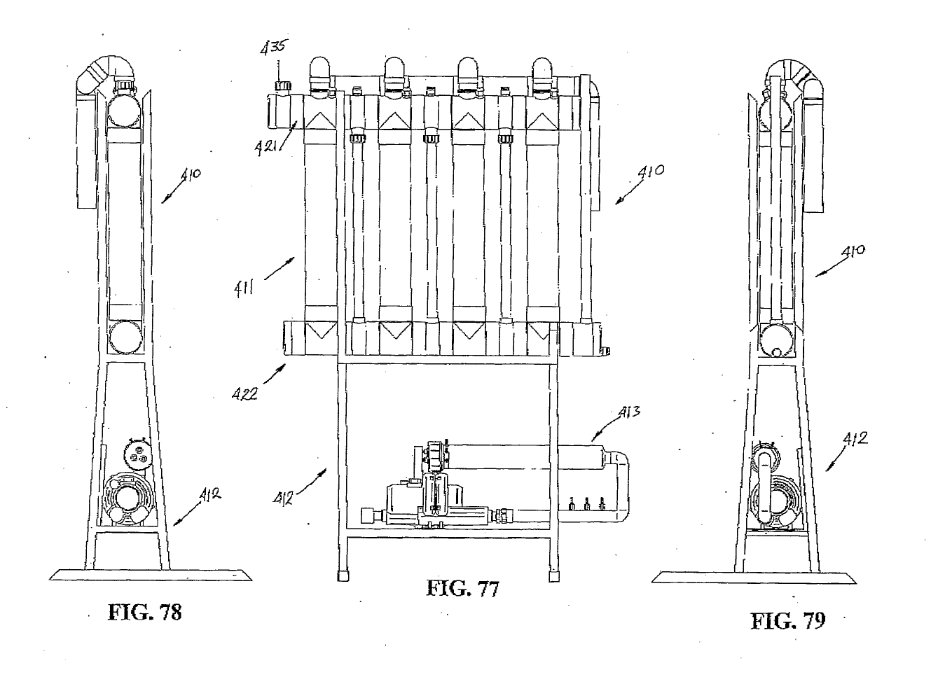

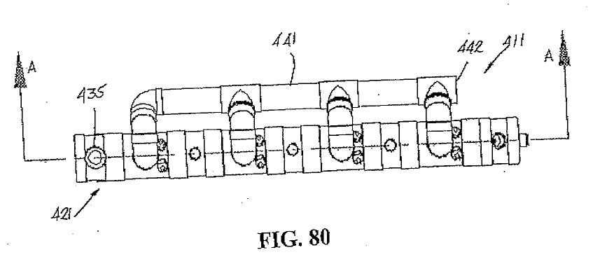

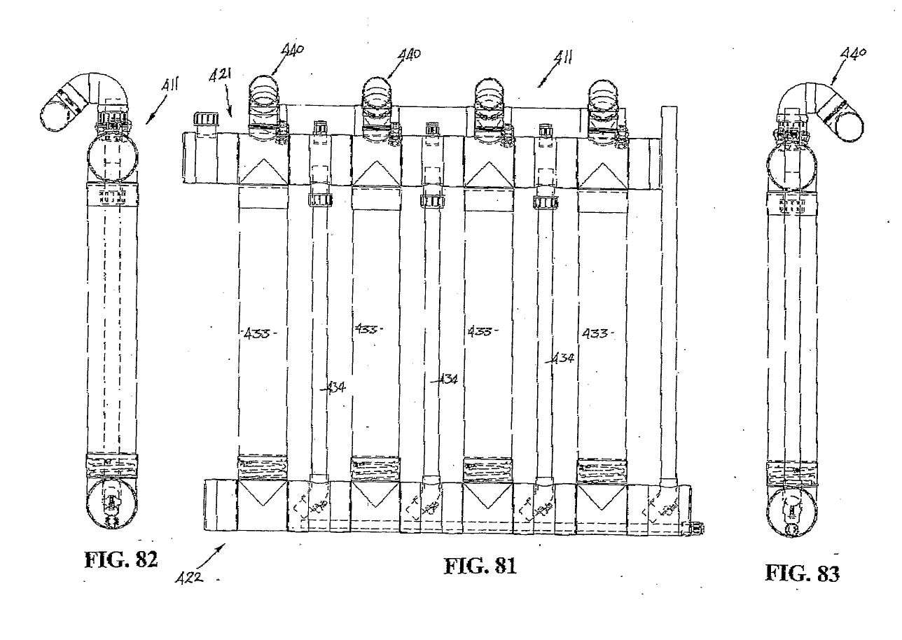

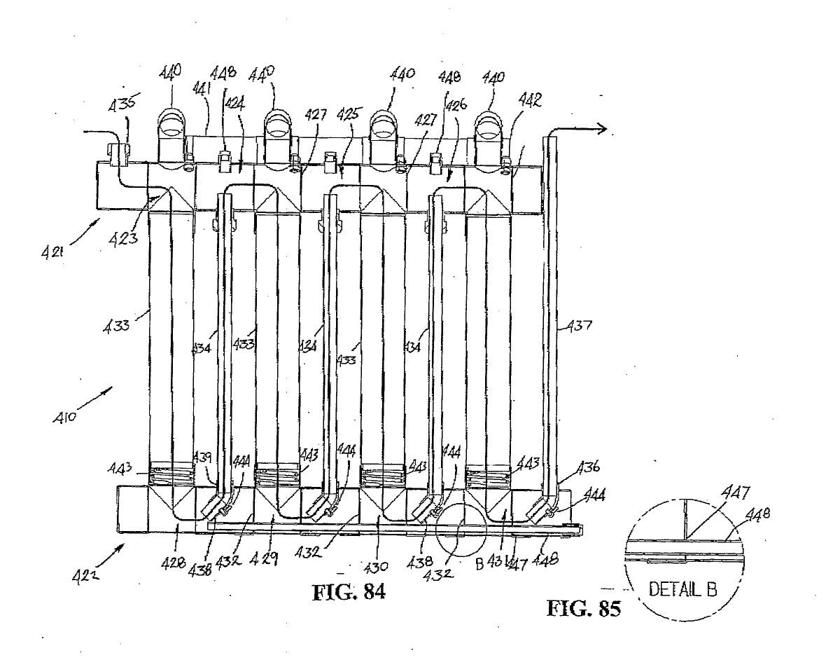

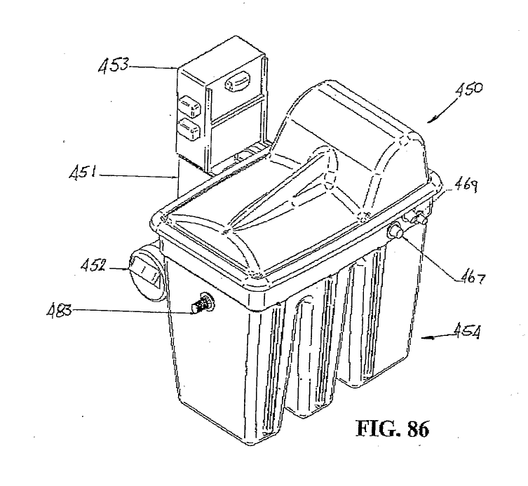

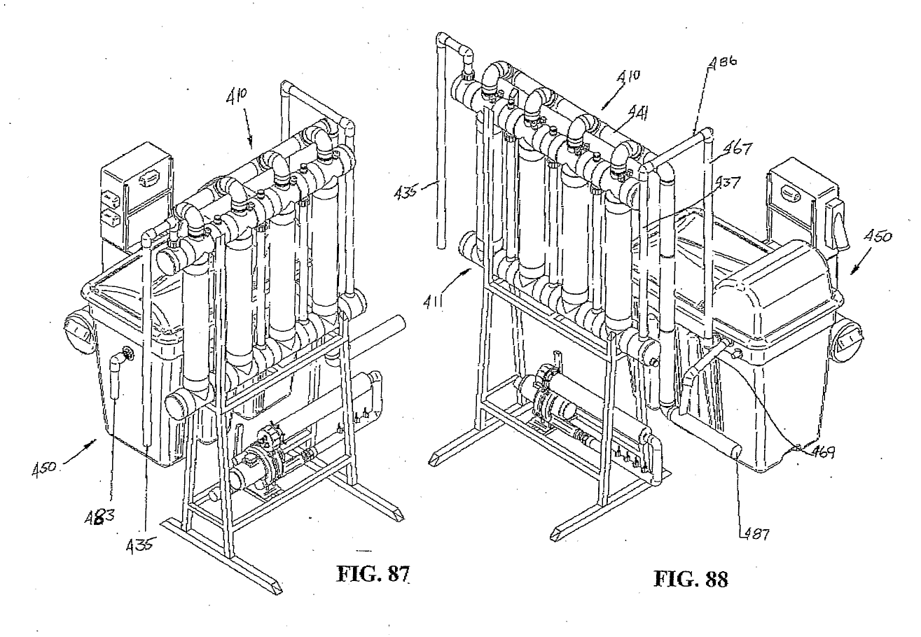

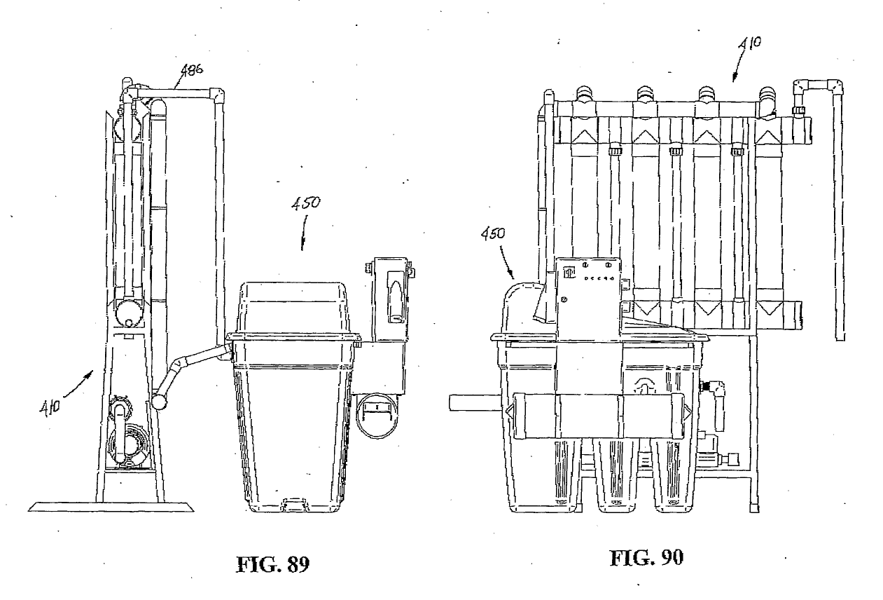

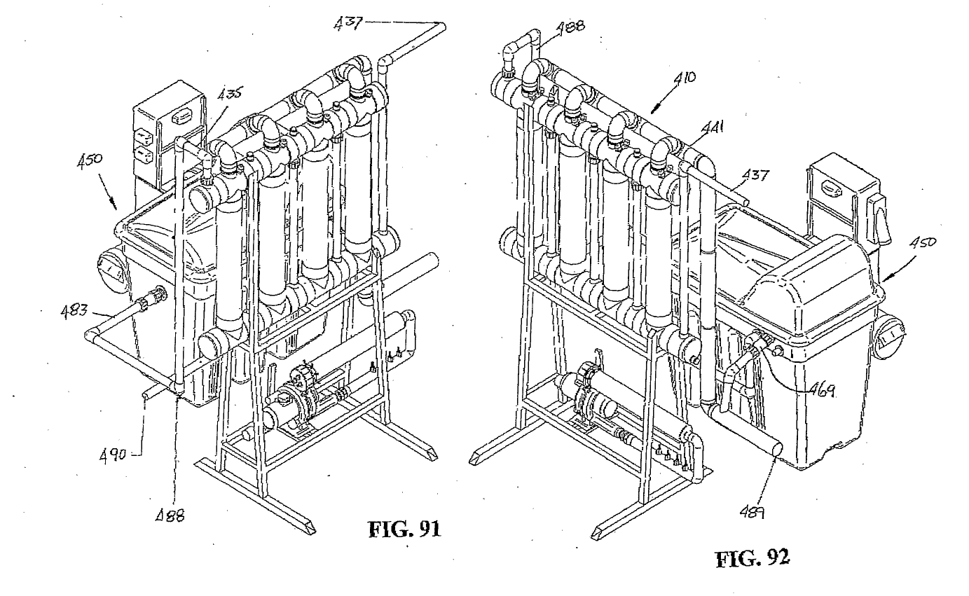

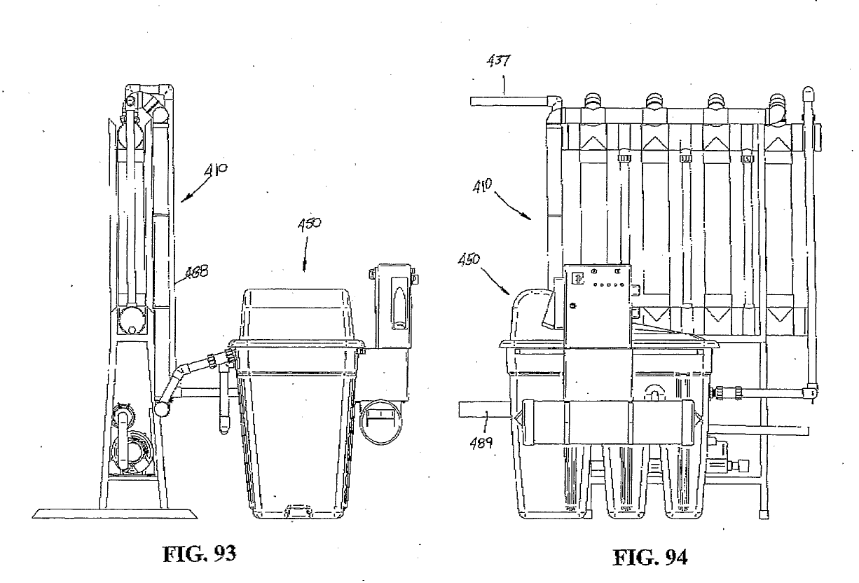

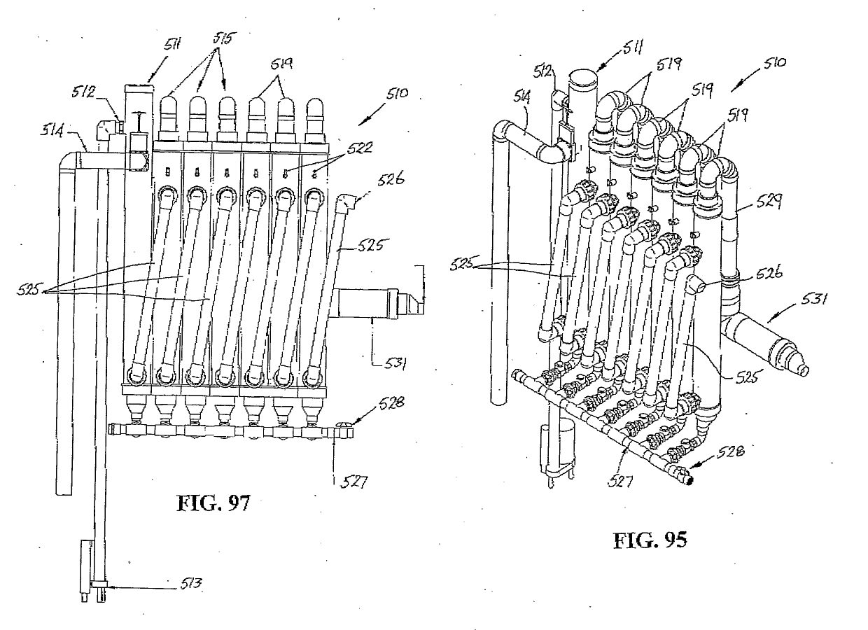

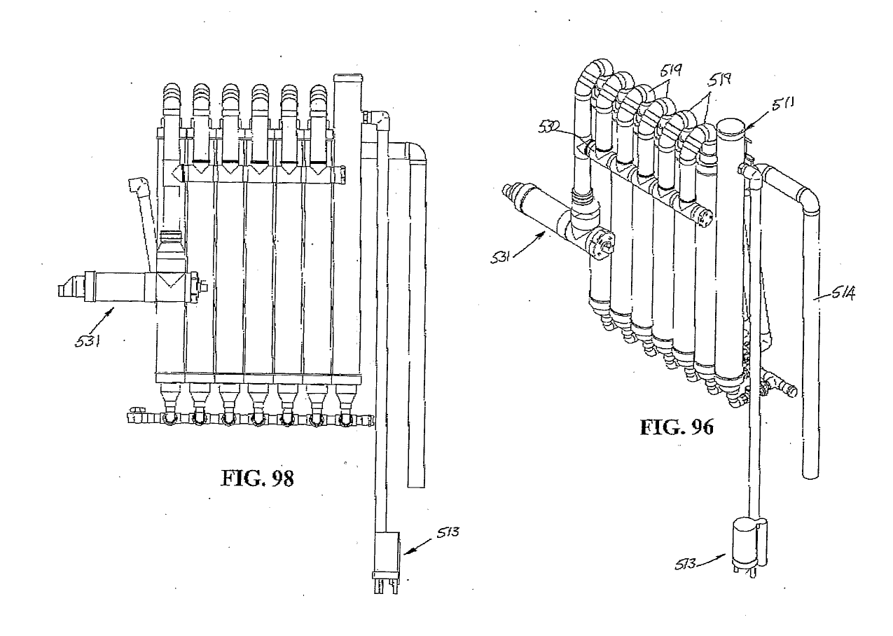

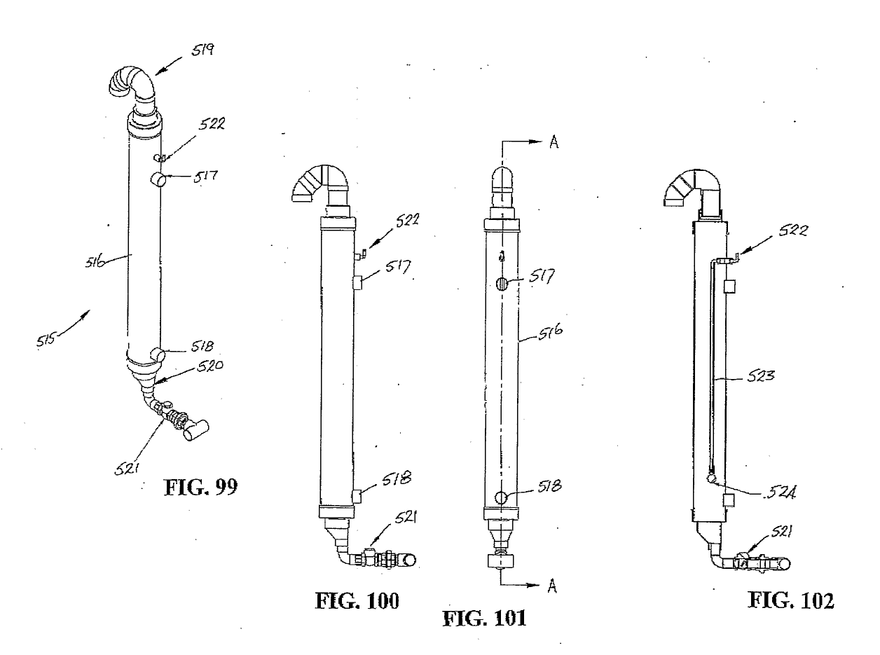

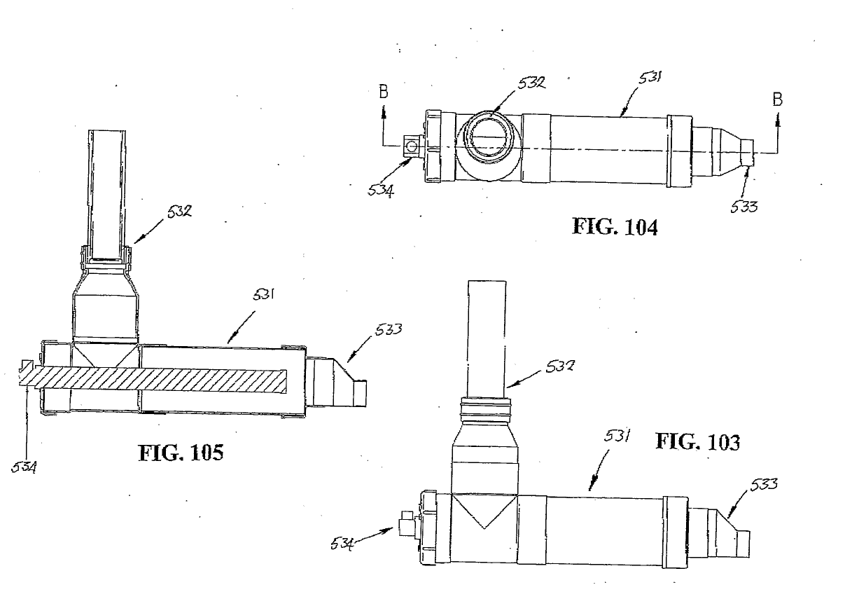

FIGS. 44 and 45 illustrates a water treatment apparatus 183 including three treatment units 158 of the type shown in FIGS. 33 to 37 arranged in series with swirl or settling tanks 184 arranged positioned in series with the units 158. One settling tank 184 is arranged between the treated water outlet of the first water treatment unit 158 and the inlet of the second water treatment unit 158 and a further settling tank 184 arranged between the outlet of the first water treatment unit 158 and inlet of the third water treatment unit 158. The tanks 184 allow solids such as sediments in the water to settle out of the treated water as it passes through the water treatment apparatus 183. Each settling or swirl tanks 184 has a tapered hopper shaped base 185 terminating in a valve controlled outlet 86 such that sediments or contaminants settling in the lower end of the tank 184 is directed by the base 186 towards the outlet 186. The solids and sediment may then be purged by opening of the valve control outlet 186. For purging of the sediments from the tank 184, the tanks 184 have removable lids 187 to provide access to the interior of the tanks 184. The water treatment apparatus 183 may include any number of treatment units 158 arranged in seines with or without settling or swirl tanks.

One or more of the units 158 may be replaced by a water treatment unit 178 of the type illustrated in FIGS. 38 to 43 for ultraviolet treatment of water. Furthermore any of the apparatuses or units described above may be associated with one or more settling or swirl tanks of the type shown in FIGS. 44 and 45.

FIGS. 46 and 47 illustrate combined water treatment apparatus 188 according to another embodiment of the invention including a water treatment unit 158 of the type illustrated in FIGS. 33 to 37 arranged in series with a modular water treatment unit 189 of the type disclosed in our International Patent Application No. PCT/AU2006/000729. The water treatment unit 189 has an inlet 190 for water to be treated and an outlet 190 connected to the inlet 171 to the water treatment unit 158. Water supplied to the unit 189 through the inlet 190 initially passes through a drum filter 192 where it undergoes screen filtering to screen out solids or other particulate matter. Solids collected by the drum filter 192 are directed to waste through an outlet 193 from the unit 189. Water passing through the drum filter 192 is subject to biological treatment by bacteria supported on media in the chamber 194 beneath the drum filter 192. Water then passes through the chambers 195 and 196 where it is exposed to ultraviolet light and/or ozone before passing out of the outlet 191 into the water treatment unit 158. Treated water passes through the outlet 172 from the water treatment unit 158 with foam wastes passing through the outlet 175.

Referring now to FIGS. 48 to 51 there is illustrated water purifying or treatment apparatus 210 according to an embodiment of the present invention typically for treating contaminated water such as grey water, or water from a vehicle washing establishment or for treating any other water. The apparatus 210 includes upper and lower hollow manifolds 211 and 212, the manifold 211 being divided into four clambers 213, 214, 215 and 216 by respective water impervious transverse walls 217 spaced along the manifold 211. The manifold 211 typically is in the form of a tubular pipe of any cross section.

The lower manifold 212 is divided into three chambers 218, 219 and 220 by two water impervious transverse walls 221. As with the manifold 211, the manifold 212 typically is in the form of a tubular pipe of any cross section.

The main treatment pipes or tubes 222 extend between and are connected to the respective opposite chambers 213 and 218, 214 and 219 and 215 and 220. Further sets of three return pipes 223, 224, and 225 of smaller diameter or cross sectional area than the pipes 222 extend between the respective opposite chambers 214 and 218, 215 and 219 and 216 and 220. An inlet 226 for water to be treated is connected to the chamber 213 whilst an outlet 227 for treated water is connected to the chamber 216. Upright foam collecting pipes 228 are connected at their lower ends to the respective chambers 213, 214 and 215 and connected at their upper ends to a foam waste pipe 229. The pipe 229 is connected through a trap 230 to a foam reduction/water recovery tank 231.

Gas outlets 232 in the form of gas permeable pipes, air stones or of any other form are provided in the lower ends of the pipes 222. Further gas outlets 233 in the form of nipples or nozzles or outlets or any other form are provided at the lower ends of the respective pipes 223, 224 and 225 which are located in the respective chambers 218, 219 and 220. The gas outlets 232 are connected in use to an ozone source. The outlets 233 may also be connected to a source of ozone and/or air.

In use water to be treated is supplied to the inlet 226 and flows in a serpentine manner as indicated by the arrows in FIG. 51 down the respective pipes 222 and up the smaller diameter pipes 223, 224 and 225 and through the respective chambers 213, 218, 214, 219, 215, 220 and 216 to the treated water outlet 227. Ozone from the outlets 232 passes as bubbles up the pipes 222 against the downward water flow. Any foam created in the manifold 211 by bubbles of gas reaching the surface of the water in the manifold 211 collects in the pipes 228 and is directed to the common foam waste pipe 225. Air or ozone or an air/ozone mixture exiting the outlets 233 passes as bubbles up the pipes 223, 224 and 225 to act as an air lift to assist in water flow upwardly through the pipes 223, 224 and 225.

Foam collecting in the waste pipe 229 passes through the inverted V-shaped trap 230 for further processing. The trap 230 ensures that water condensing out of the foam in does not pass to waste but will flow downwardly under the influence of gravity for further processing by the apparatus 210.

Treated water exits from the apparatus 210 through the outlet 227 and the outlet 227 may be connected back to the inlet 226 for further treatment by passing through the apparatus 210.

The outlet 227 from the apparatus 210 alternatively of additionally may be connected to a, screen filter such as a drum filter for filtering solids in the water. The outlet 227 alternatively or additionally may be connected to an UV treatment unit to skill pathogens in the water.

The tank 231 for treatment of foam as shown in FIGS. 52 to 54 has an inlet 234 at its upper end connected through the trap 230 to the waste pipe 229 and a frustoconical base 235 terminating in a central outlet 236 controlled by a valve 237. Sediment or contaminants settling in the base 235 of the tank 231 are directed towards the outlet 236 through which they may be purged or empties when the valve 237 is opened. A foam outlet 238 is provided towards the upper end of the tank 231. If the foam in the tank 231 reaches the level of the outlet 238, it will pass through the outlet 238 to waste. A water recovery outlet duct 239 also extends into the lower part of the tank 231 adjacent the base 235, the duct 239 having a downwardly extending portion 240. This allows for recovery of condensing water from the tank 231 for retreatment if required.

To reduce the foam in the tank 231, an air or water distributor 241 through which air or water may be sprayed over the foam in the tank 211 is provided at the upper end of the tank 211. The distributor 241 in the embodiment is be in the form of an apertured pipe of annular form but may be in any other configuration.

The water purifying or treatment apparatus 242 illustrated in FIGS. 55 to 57 is similar to the apparatus 210 of FIGS. 48 to 51 however in this case the pipes 223, 224 and 225 are provided with inline liquid pumps 243 for pumping water upwardly through the pipes 223, 224 and 225 rather than using the air lift arrangement described with reference to FIGS. 48 to 51. Alternatively the pumps 243 may inject external air into the pipes 223, 224 and 225 to convey water upwardly through the pipes.

Referring now to FIG. 58 there is illustrated water treatment apparatus 210 (or 242) associated with an alternative foam treatment apparatus 243 which is connected to the foam waste pipe 229 through the trap 230.

The apparatus 243 as shown more clearly in FIGS. 59 to 62 uses a centrifugal principal to reduce the foam to liquid. The apparatus 243 includes an outer hollow housing 244 supported in an upright attitude by a frame 245. The housing 244 has an inlet 246 at its upper and an outlet 247 at its lower end. A drum 248 having a perforated outer cylindrical wall is mounted in the housing 244 for rotation about a substantially vertical axis and is supported to the housing 244 for this purpose by a bearing 249 at its upper end. A drive shaft 250 is coupled centrally to the drum 248 at is lower ends the shaft 250 either being a shaft of a drive motor 251 or being coupled to the motor 251. The motor 251 is provided externally of the housing 244 and supported on the frame 245. The upper end of the drum 248 is open and as shown the inlet 246 extends into the drum upper end.

In operation, foam supplied to the inlet 246 passes into the interior of the drum 248 which is driven in rotation by the motor 251. The foam during rotation of the drum 248 is reduced to liquid which passes out through the perforated wall of the drum 248 and out through the outlet 247 to waste.

The apparatus 210 and/or 242 described above may be used in multiples in series or in parallel with each other and used with different combinations of other water treatment components employed in series or parallel with the apparatus described. A drum or screen filter may also be provided before the inlet to the apparatus 210 or 242 so that water flowing into an apparatus 210 or 242 is initially screen filtered.

The foam treatment tanks and apparatus described above with reference to FIGS. 52 to 54 and 59 to 62 may be used separately in other applications to recover water or liquid from foam.

Referring now to FIGS. 63 to 65, there is illustrated water purifying or treatment apparatus 310 according to another embodiment of the present invention which includes a defoaming unit 311, an ozone-contacting unit 312 and an ultraviolet treatment unit 313. The apparatus 310 additionally includes in this embodiment a drum filter unit 314.

The defoaming unit 311 (shown also in FIG. 66) which is for removing foam of from water to be treated includes an inlet 315 for water to be treated which is normally connected to a holding tank (not shown) and an outlet 316 to the holding or a further holding tank. The unit 311 includes two defoaming modules 317 which are connected in parallel with the inlet 315 being connected to both inlets to the modules 317 and the outlet 316 being connected to the outlets of the modules 317.

Each module 317 comprises three treatment devices 318, 319 and 320 (shown in FIGS. 68, 69 and 70) connected in series in the manner shown in FIG. 71. The treatment device 318 as shown in FIG. 68 (c) includes upper and lower hollow manifolds 321 and 322, the manifold 311 being divided into four chambers 323, 324, 375 and 326 by respective water impervious transverse walls 327 spaced along the manifold 321. The manifold 321 typically is in the form of a tubular pipe of any cross section.

The lower manifold 322 is divided into three chambers 328, 329 and 330 by two water impervious transverse walls 331. As with the manifold 321, the manifold 322 typically is in the form of a tubular pipe of any cross section.

Pipes or tubes 332 extend between and are connected to the respective opposite chambers 323 and 328, 324 and 329 and 325 and 330. Further sets of three return pipes 333 of smaller diameter or cross sectional area than the pipes 332 extend between the respective opposite chambers 324 and 328, 325 and 329 and 326 and 330. An inlet 334 for water to be treated is connected to the chamber 323 whilst an outlet 335 for treated water is connected to the chamber 326. Upright foam collecting pipes 336 are connected at their lower ends to the respective chambers 323, 324 and 325 and connected at their upper ends to a foam waste pipe 337.

Gas or air outlets 338 in the form of gas permeable pipes, air stones or of any other form are provided in the lower ends of the pipes 332. Further gas or air outlets 339 in the form of nipples or nozzles or outlets or any other form are provided at the lower ends of the respective pipes 333 which are located in the respective chambers 328, 329 and 330. The gas outlets 338 are connected in use to an ozone source. The outlets 339 are connected in use to a source of air such as an air pump.

In use water to be treated is supplied to the inlet 334 and flows in a serpentine manner as indicated by the arrows in FIG. 68 (c) down the respective pipes 332 and up the smaller diameter pipes 333 and through the respective chambers 323, 328, 324, 329, 325, 330 and 326 to the treated water outlet 335. Ozone from the outlets 338 passes as bubbles up the pipes 333 against the downward water flow. Any foam created in the manifold 321 by bubbles of gas reaching the surface of the water in the manifold 321 collects in the pipes 336 and is directed to the common foam waste pipe 337. Air exiting the outlets 339 passes as bubbles up the pipes 333 to act as an air lift to assist in water flow upwardly through the pipes 333.

The second treatment device 319 shown in FIG. 69 is similar to the device 318 and like components has been given like numerals. In this case however, pairs of return pipes 333 are provided in place of each single return pipe 333 of the device 318 of FIG. 68. Each return pipe 333 has an air inlet 339 for supply of air to the return pipes 333. This provides for increased vertical lift of water through the return pipes 333.

The third treatment device 320 shown in FIG. 70 is similar to the device 319 of FIG. 69 having pairs of return pipes 333 each of which is provided with a pair of air inlets 339 at their lower ends to again provided increased vertical lift of water through the return pipes 333 as compared to the lift proved in the device 319.

As shown in FIG. 71, the devices 318, 319 and 320 are connected in series with connecting U-pipes 340 connecting the outlet 335 of the device 318 to the inlet 334 of the device 319 and the outlet 335 of the device 319 to the inlet 334 of the device 320 so that increased air lift or pump occurs in the each following device.

In addition and as shown in FIG. 66, the respective foam waste pipes 337 are connected to a common peripherally extending waste manifold 341 having a foam outlet 342. A foam centrifuge 343 (see FIGS. 63 to 65) which is similar to that shown in FIG. 14 receives the foam from the foam outlet 342 to reduce the foam to liquid for passage to waste.

Ozone for use in the defoaming unit 311 is supplied from an ozone producer 344 shown more clearly in FIG. 72. The ozone producer 344 comprises an inlet manifold 345 and a series of parallel cylindrical hollow housings 346 connected at one end 347 to the manifold 345. Each housing 346 is closed by a screwed on end cap 348 at its other end, the end cap 348 supporting the terminal ends of three equispaced ultraviolet lamps 349 which extend longitudinally of the housing 346 and which are supported at their other end by a spacer 350. Pairs of ozone outlets 351 are provided on the housing 346 adjacent the end cap 348. The ultraviolet lamps 349 emit ultraviolet light of a wavelength to convert oxygen in air flowing into the housing 346 into ozone, being a wavelength usually less than 210 nanometers and typically 185 nanometers.

The inlet 352 to the inlet manifold 345 is connected to an air pump 353 (see FIG. 66) so that air pumped into the manifold 345 passes into each housing 346 where oxygen in the air is exposed to ultraviolet light emitted by the lamps 349 to convert the oxygen into ozone. Ozone is then supplied from the outlets 351 via connecting tubes (not shown) to the ozone outlets 338 of each treatment device 318, 319 and 320.

As illustrated in FIGS. 63 to 66, the ozone producer 343 is supported in a horizontal attitude on the foam waste pipes 337 of the respective treatment units 318, 319 and 320. The ozone generators defined by each housing 346 and ultraviolet lamps 349 may as an alternative be of the configuration shown and described above in our International Patent Application No. PCT/AU2005/001259

The ozone contacting unit 312 is of a similar construction to the defoaming unit 311 and like components thereof have been given like numerals designated by a prime (′).

The unit 312 thus includes two modules 317′ connected in parallel to an inlet 16′, each module 317′ comprising three treatment devices 318, 319′ and 320′ connected in series and being of the same construction to that shown in FIGS. 68 to 71. Thus water to be treated flows into the inlet 316′ and is treated in each device 318, 319 and 320 of each module 317′ where it is exposed to ozone supplied through the ozone outlets 338. As with the defoaming unit 311, an ozone producer 344 is supported above the ozone-contacting unit 312 for supplying ozone to the ozone outlets 338. As with the defoaming unit 311, a common peripherally extending waste manifold 341′ is connected to the foam waste pipes 337′ with the outlet 342′ from the waste manifold 341′ supplying foam to the common foam centrifuge 343.

The ozone contacting unit 312 includes a pair of outlets 354 from the trailing treatment device 320′ of each module 317′ which are connected to the ultraviolet treatment unit 313.

The ultraviolet treatment unit 313 as shown more clearly in FIGS. 73 to 75 includes a U-shaped housing or pipe 355 having first and second upright hollow housing portions 356 joined at their lower ends by a connecting duct 357. A pair of parallel ultraviolet lamps 358 are provided in each housing portion 356 to extend longitudinally thereof, each lamp 358 being located within a tubular sleeve or casing 359 of transparent material, typically glass. The upper ends of the lamps 358 extend at 360 out of the upper ends of the housing portions 356 (which are closed). The lower ends of the lamp selves or casings 359 extend through and are supported by disc-like flow control plates 361 which extend transversely of the housing portions 356 and which are located neatly therein, having an outer diameter substantially the same as the inner diameter of the housing portions 356. Each flow control plate 361 is provided with a plurality of openings 362 therein to cause water flowing into the inlets 354 to be forced through the gap between the ultraviolet lamps 358. A single outlet 363 for water exposed to ultraviolet light from the lamps 358 is connected through an inverted U-shaped trap 364 to the connecting duct 357.

The outlet 363 may be connected to the drum filter unit 314 (see FIGS. 63 to 65) for final treatment of water. The drum filter unit 314 includes an open-topped chamber 365 in which a filter drum 366 is supported for rotation about a horizontal axis. The outlet 363 is connected to a duct extending into the filter drum 366 such that water flowing into the drum 366 effects rotation of the drum. Filtered water passing through the drum 366 collects in the chamber 365 and passes out through a filtered water outlet 367. A trough 368 within and extending longitudinally of the drum 366 collects waste materials on the screen or filter material from the drum 366 which are washed or displaced from the screen or filter material by a air and/or water spray duct 369 above the drum 366. A waste outlet 370 is provided for directing materials collecting in the trough 368 to waste. The drum filter unit 334 may be of similar configuration to the drum filter unit disclosed in our International Patent Application No. PCT/AU2005/000878 or PCT/AU02/01245.

In use untreated water is pumped from a holding tank to the inlet 316 to the defoaming unit 311 for removal of foam and suds and for ozone treatment and treated water is then returned to the or a further holding tank. The water is then pumped from that holding tank to the ozone-contacting unit 313 for ozone treatment. The ozone treated water then passes to the UV treatment unit 313 and then through the drum filter unit 314. The outlet from the drum filter unit 314 is then pumped to a separate holding tank ready for use. Foam from both the defoaming unit 311 and ozone contacting unit 313 passes to a common centrifuge 343 for reducing in volume before being directed to waste such as a sewer.

The apparatus 310 described above may be used with defoaming unit 311 and ozone unit 313 in series or in parallel with each other and used with different combinations of other water treatment components employed in series or parallel with the apparatus described. A drum or screen filter may also be provided before the inlet to the apparatus 310 so that water flowing into an apparatus 310 is initially screen filtered. The drum filter unit 314 may be replaced by an alternative form of screen filter whist in some embodiments the dram filter unit 314 may not be required. The modules 317 and 317′ of the defoaming unit and ozone unit may have any number of devices 318, 319 and/or 320 arranged in series of parallel.

Whilst the defoaming unit 311 is shown to use both ozone and air, the ozone outlets 338 may be connected alternatively to a source or sources of air. Alternatively an ozone source may be connected to both the outlets 338 and outlets 339. Similarly the outlets 339 of the treatment units of the modules 317′ may be connected to a source or sources of ozone. Different types or combinations of gases may also be used in the apparatus instead of the ozone/air arrangements described.

The defoaming unit 311 and ozone contacting units 312 may be used separately in other applications for water treatment. The ultraviolet treatment unit 313 may also be used in other water treatment applications.

Referring to FIGS. 76 to 79, there is illustrated water purifying or treatment apparatus 410 according to another embodiment of the present invention including a water treatment unit 411 supported in an upright attitude on a support frame 412, the frame 412 also supporting ozone generator unit 413 comprising an air pump 414 connected though an outlet line 415 to a housing 416 which contains one or more ultraviolet lamps which emit ultraviolet light at a wavelength usually less than 210 nanometers and typically 185 nanometers to convert oxygen pumped in the housing 416 with air from the pump 414 into ozone. A plurality of air outlets 417 are provided in the pump outlet line 415 whilst a plurality of ozone outlets 418 are provided in the housing 416. The ozone generator unit 413 may be of the type disclosed in our International patent application No. PCT/AU2005/01259.

The water treatment unit 411 as also shown in FIGS. 80 to 85 comprises upper and lower hollow manifolds 421 and 422, the manifold 421 being divided into four chambers 423, 424, 425 and 426 by respective water impervious transverse walls 427 defined by dividing discs spaced along the manifold 421. The manifold 421 typically is in the form of a tubular pipe of any cross section or made up of pipe connectors. Thus the manifolds may be defined by four joined T-connectors.

The lower manifold 422 is of a similar construction and divided into four chambers 428, 429, 430 and 431 by water impervious transverse walls 432 also defined by dividing discs.

Four pipes or tubes 433 extend between and are connected to the respective opposite chambers 423 and 428, 424 and 429, 425 and 430 and 426 and 431. Three return pipes 434 of smaller diameter or cross sectional area than the pipes 433 are arranged parallel to the pipes 433 and extend between the upper and lower manifolds 420 and 421 to provide communication between the respective opposite chambers 424 and 428, 425 and 429 and 426 and 430. An inlet 43.5 for water to be treated is connected to the chamber 423 whilst an outlet 436 for treated water communicates with the chamber 431 and is connected to an upright outlet pipe 437. The lower ends 438 of the pipes 434 are angled at an obtuse angle so as to be directed towards the flow of water into the pipes 434. This may be achieved by providing pipe angle fittings 439 at the pipe lower ends 438.

Four U-Shaped waste collecting pipes 440 are connected at one end to the respective chambers 423, 424, 425 and 426 connected at their opposite ends to a common waste pipe or manifold 441 having an outlet 442.

Gas or air outlets 443 in the form of gas permeable pipes, air stones or outlets of any other form are provided in the lower ends of the pipes 433. Further gas or air outlets 444 in the form of nipples or nozzles or outlets or any other form are provided at the lower ends of the respective pipes 434 which are located in manifold 422. The gas outlets 443 are connected to the ozone outlets 418 of the ozone generator 413 so that ozone-enriched air is provided to the outlets 443. Alternatively, the gas outlets 443 may be used to inject oxygen, or any other gas into the pipes 433. The outlets 444 are connected to the air outlets 415 for supply of air to the pipes 434 which act as air pumps. Alternatively the outlets 444 may be connected to a, source of any other gas.

The pipe lines for supply of ozone to the outlets 443 which are in the form of flexible tubes pass through glands 445 in the manifold 420 and extend down the pipes 433 for connection to the outlets 443. Similar glands 446 are provided for the air lines. Ports 448 are also provided in the manifold 421 to provide access to the manifold 421 for cleaning purposes, the ports 448 being normally closed by screw caps.

As shown in FIGS. 84 and 85, the dividing discs or walls 432 are provided with apertures 447 which are longitudinally aligned along the manifold 422. An elongated rod-like or tubular member 448 extends longitudinally through a drain port 449 at the end of the manifold 422 and through the apertures 447 to close and seat the apertures 447 to maintain the separation between the chambers 428, 429, 430 and 431. When however it is desired to drain the chambers, the member 448 is withdrawn through the drain port 449 which allows water to drain through the port 449.

In use water to be treated is supplied to the inlet 435 and flows in a serpentine manner as indicated by the arrowheaded line in FIG. 84 down the respective pipes 43 and up the smaller diameter pipes 434 and through the respective chambers 423, 428, 424, 429, 425, 430, 426 and 431 to the treated water outlet 436 to exit through the outlet pipe 437. Ozone and/or air from the outlets 443 passes as bubbles up the pipes 433 against the downward water flow. Any foam created in the manifold 421 or wastes in the water are carried by bubbles of gas reaching the surface of the water in the manifold 421 and collects in the waste pipes 440 and is directed to the common waste pipe or manifold 441. Air exiting the outlets 444 passes as bubbles up the pipes 434 to act as an air lift or air pump to assist in water flow upwardly through the pipes 434.

To enhance the removal of impurities from the water being treated in the apparatus 410 a foaming agent may be added to water at the inlet 435 to the unit 411 to assist in removing impurities from the water such as heavy metals. The foaming agent may comprise an environmentally friendly detergent or any frothable agent such as molasses. The foaming agent will create a foam in the pipes 433 which will carry heavy metals upwardly through the pipes 433 for collection in the waste pipes 440 which are directed to waste through the waste line 441.

The water treatment unit 410 may be used separately or in combination with the drum filter module 450 which is similar to that described in our International patent application No. PCT/AU2006/000729. Mounted on the side of the filter module 450 is an air blower 451, and ozone producer 452 of the above described type and an electrical housing 453 for housing electrical components use in association with the module 450.

The water treatment apparatus 410 of FIGS. 76 to 85 may be used in combination with the drum filter module 50 in the manner shown in FIGS. 87 to 90. The apparatus 410 and module 450 are connected in series with the outlet 437 from the water treatment unit 411 being connected to the inlet 467 of the drum filter module 450 through connecting pipe 486. Further the waste pipe 441 from the unit 411 and the waste outlet 469 from the module 450 are connected to a common waste outlet 487. Water thus is initially treated in the unit 411 and then flows into the drum filter module 450 for further treatment with the treated water exiting through the outlet 483.

In an alternative configuration shown in FIGS. 91 to 94, the water treatment apparatus 410 is again used in combination with the drum filter module 450 but in a reversed arrangement compared to that shown in FIGS. 87 to 90. The apparatus 410 and module 450 are connected in series with the outlet 483 from the module 411 being connected to the inlet 435 of the water treatment unit 411 through connecting pipe 488. The waste pipe 441 from the unit 411 and the waste outlet 469 from the module 450 are connected to a common waste outlet 489. An extended inlet pipe 490 is connected to the drum filter module inlet 467. Water thus is initially treated in the module 450 and then unit 411 for further treatment with the treated water exiting through the outlet 437.

The water treatment apparatus of the present invention may be used for grey water treatment, as a swimming pool water cleaner, as a sewerage recycling unit, a urinal-trough water to toilet-flush water converter, as an aquaculture water remediation system, as a drinking water treatment system or in any other water treatment application.

The water treatment apparatus described with reference to FIGS. 76 to 85 may be used in any application in combination with or separate from the drum filter module 450.

Referring now to FIGS. 95 to 98, there is illustrated further water purifying or treatment apparatus 510 according to another embodiment of the present invention, the apparatus 510 including and upright hollow reservoir 511 which comprises a tubular member and which has an inlet 512 connected to an upper end thereof. An inlet pump 513 is connected to the inlet for supplying water to be treated from any source to the reservoir 511. An overflow pipe 514 is also connected to the reservoir through a gate valve 515.

The apparatus 510 includes a series of substantially vertical ozone contact and fractionator chambers 515. Each chamber 515 as shown in FIGS. 99 to 101 comprises an elongated tubular member 516 having an inlet 517 towards its upper end and an outlet 518 at its lower end. The tubular member 516 additionally includes a foam outlet 519 at its upper end which is of a generally U-shaped configuration. At its lower end, the tubular member 515 is provided with a funnel-shaped waste outlet 520 connected ton a one-way valve 521. A diffuser inlet 522 is penetrates the wall of the tubular member 515 at a position above the inlet 517 and is connected to a pipe or tube 523 which extends downwardly within the member 515 to terminate in an outlet or diffuser 524 towards the lower end of the member 515.

The ozone contact chambers 515 are arranged in a juxtaposed position relative to each other and a series of return or transfer pipes 525 are connected between the outlet 518 of one chamber 515 and the inlet 517 of the adjacent chamber. The trailing or final return or transfer pipe 525 terminates in a treated water outlet 526. The respective waste outlets 520 of the respective chambers 515 are connected through the respective one-way valves 521 to a common waste outlet line 527 which terminates in an outlet valve 528. The one-way valve 521 may be a manually operable valve or may be a solenoid actuated valve. Alternatively the valve 521 may be replaced by a pump controlled by a timer.

The respective foam outlets 519 are connected to downwardly extending pipes 529 which are connected to a common foam outlet pipe 530. The common outlet pipe 530 is connected to a foam reduction chamber 531. The chamber 531 as shown in FIGS. 103 to 105 has an inlet 532 connected to a side of the common foam outlet pipe 530 and a waste outlet 533 at one end of the chamber 531. Extending coaxially into the opposite end of the chamber 531 is a heating element 534. The heating element 534 may alternatively be replaced by a microwave emitter or ultrasonic vibrator.

In use water to be treated is pumped by the inlet pump 513 to the reservoir 511 and when the level or water in the reservoir 511 reaches the level of the inlets 517, water will flow into the adjacent ozone contact chamber 515. Continued supply of water to the reservoir will result in water being supplied to the respective chambers 515 through the respective transfer pipes 525 such that it flows in a serpentine manner through the apparatus 510 flowing down the respective chambers 515 and up the smaller diameter transfer pipes 525 to the final transfer pipe 525 and treated water outlet 526. Ozone or ozone enriched air supplied to the inlets 522 flows down the pipes 523 to the diffusers or outlets 524 to pass as bubbles upwardly through the chambers 515 against the downward water flow. The bubbles of gas reaching the surface of the water in the respective chambers will carry waste particles to the surface and create foam in the respective chambers 515. The foam passes upwardly through the foam outlets 519 and passes downwardly through the pipes 529 to the common foam outlet pipe 530. The foam in the foam outlet pipe 530 passes to the foam reduction chamber 531 which is reduced in volume by being exposed to the heat of the heating element 534 before passing to waste through the outlet 533. Larger particles collected in the waste outlets 520 of the respective chambers 515 will pass through the one-way valves 521 into the common waste outlet line 527 and the valve 528 may be opened periodically to purge large particles from the chambers 151.

If desired, air may be supplied to the transfer pipes 525 in the form or bubbles for flow up the pipes 525 to act as an air lift or air pump to assist in water flow upwardly through the pipes 434.

To enhance the removal of impurities from the water being treated in the apparatus 510 a foaming agent may be added to water in the reservoir 511 to assist in removing impurities from the water such as heavy metals. The foaming agent may comprise an environmentally friendly detergent or any frothable agent such as molasses.

The water treatment apparatus 510 as described above may be used in many different applications and used in combination with other water treatment apparatus described in the above embodiments such as a drum filter module or ultraviolet treatment unit described for example in FIG. 63 or 86 or FIGS. 72 to 75.

The water treatment apparatuses and units of the invention are typically fabricated from plastic pipes however they may be constructed of other materials. The pipes which form the apparatus or units, may be joined through suitable connectors or bent into the required shape to form the required connections or joins.

It should be noted that, reference to the prior art herein is not to be taken as an acknowledgement that such prior art constitutes common general knowledge in the art.

The terms “comprising” or “comprise” or derivatives thereof as used throughout the specification and claims are taken to specify the presence of the stated features, integers and components referred to but not preclude the presence or addition of one or more other feature/s, integer/s, component/s or group thereof.

Whilst the above has been given by way of illustrative embodiment of the invention, all such variations and modifications thereto as would be apparent to persons skilled in the art are deemed to fall within the broad scope and ambit of the invention as herein described in the appended claims.

1-30. (canceled)

31. Water treatment apparatus comprising:
a plurality of elongated water treatment chambers, each said chamber being normally oriented in a substantially vertical attitude,
an inlet for water to be treated in an upper region of each chamber and an outlet for treated water at a lower region of each chamber,
interconnecting means interconnecting said outlet one said chamber with an inlet of an adjacent said chamber whereby water to be treated flows downwardly through each said chamber and sequentially from one chamber to the adjacent chamber,
means for supplying a gas to the lower regions of the respective said chambers for bubbling upwardly through water flowing in said chambers and creating a foam at the upper surface of water in said chambers, and
foam collecting means interconnecting the upper regions of each said chamber for collecting said foam created in said chambers.

32. Water treatment apparatus as claimed in claim 31 wherein said inlet is defined in or by an upper end of a chamber and wherein said outlet is defined in or by a lower end of the chamber.

33. Water treatment apparatus as claimed in claim 32 wherein said foam collecting means comprise foam passages extending upwardly from the upper ends of the respective chambers, said foam passages including a trap or traps to prevent foam passing back into the chambers.

34. Water treatment apparatus as claimed in claim 33 wherein each said trap comprises an inverted U-shaped member for directing foam at the upper ends of the chambers downwardly away from the chambers.

35. Water treatment apparatus as claimed in claim 34 wherein said foam passages are connected to a common foam waste passage for receiving foam from the foam passages and for directing the foam to waste or for further processing and treatment.

36. Water treatment apparatus as claimed in claim 35 wherein said foam waste passage is substantially horizontal or inclined to the horizontal.

37. Water treatment apparatus as claimed in claim 36 wherein said common foam waste passage is disposed below the upper ends of the respective chambers.

38. Water treatment apparatus as claimed in claim 37 and including a holding container for receiving foam from said common waste passage, said holding container having an outlet at its lower end through which solids may be released, a foam inlet at its upper end and a water outlet at its lower end for outward flow of condensing water and including means for directing air or a spray of water or liquid over the foam in the container to break down the foam.

39. Water treatment apparatus as claimed in claim 31 wherein said gas comprises ozone or ozone enriched air.

40. Water treatment apparatus as claimed in claim 31 wherein said chamber interconnecting means comprise return passages and wherein water flows upwardly in said return passages in a direction opposite the flow in the chambers.

41. Water treatment apparatus as claimed in claim 40 and including a gas outlet or outlets for supplying gas to lower portions of said return passages for bubbling through water flowing in the return passages and assisting flow through said return passages.

42. Water treatment apparatus as claimed in claim 31 wherein said chambers and return passages are defined by respective pipes.

43. Water treatment apparatus as claimed in claim 42 wherein said chambers and return passages are interconnected by pipe connectors forming a U-connection between the respective pipes.

44. Water treatment apparatus as claimed in claim 42 wherein said respective pipes are connected at their lower ends through respective chambers in a lower manifold located at the lower end of the pipes.

45. Water treatment apparatus as claimed in claim 44 wherein said respective pipes are connected at their upper ends through respective chambers in an upper manifold located at an upper end of the pipes and wherein said foam collecting means comprise foam passages connecting said upper manifold to a common foam waste line.

46. Water treatment apparatus as claimed in claim 31 and including an ultraviolet treatment unit for treating of water flowing through said apparatus, said ultraviolet treatment unit comprises a transparent tube and one or more ultraviolet lamps located adjacent said tube so as to expose water flowing through said tube to ultraviolet light from said lamps.

47. Water treatment apparatus comprising:
a plurality of elongated hollow tubular members defining respective water treatment chambers, each said tubular member being oriented in a substantially vertical attitude, each said tubular member being adjacent a further said tubular member,
each said tubular member having an inlet at an upper region thereof and an outlet at a lower region thereof,
respective return or transfer pipes interconnecting said outlet of one said tubular member with an inlet of an adjacent said tubular member whereby said plurality of hollow tubular members are connected in series,
an untreated water inlet for water to be treated connected to the inlet of first leading said tubular member of said series and a treated water outlet for treated water connected to the outlet of a trailing tubular member of said series whereby water to be treated flows downwardly from said untreated water inlet through respective said chambers and upwardly through respective said return or transfer passages for sequential flow through said apparatus and outlet flow through said treated water outlet,
means for supplying a gas to respective said chambers in the lower regions of said tubular members for bubbling upwardly through water flowing downwardly in said chambers and creating a foam at the upper surface of water in said chambers,
a common foam outlet tube,
traps at the upper regions of the respective said tubular members and connecting said tubular members to said common foam outlet tube for directing foam created in the respective chambers to said common foam outlet tube.

48. Water treatment apparatus as claimed in claim 47 wherein said traps comprise U-shaped members and wherein said common foam outlet tube is below the upper regions of the respective said chambers.

49. Water treatment apparatus as claimed in claim 47 and including valves connecting said lower regions of said tubular members to a common waste outlet, said valves being selectively operable for draining said chambers to waste.

50. Water treatment apparatus as claimed in claim 47 and including gas outlets for supply of said gas to said chambers and flexible ducts connected to said gas outlets and extending to an upper region of said tubular member for connection to said supply of gas.
